(19) United States
(12) Patent Application Publication
(10) Pub. No.: US 2026/0163679 A1
(43) Pub. Date: Jun. 11, 2026

(54) HYBRID AUTOMATIC REPEAT REQUEST BUFFER MEMORY AND LOGICAL CHANNEL BUFFER MEMORY OPTIMIZATION EMPLOYING GENERATIVE ARTIFICIAL INTELLIGENCE FOUNDATION MODELS

(71) Applicant: QUALCOMM Incorporated, San Diego, CA (US)

(72) Inventors: Himanshu JOSHI, San Jose, CA (US); Ajay GUPTA, San Diego, CA (US); Vinay CHANDE, San Diego, CA (US); June NAMGOONG, San Diego, CA (US); Taesang YOO, San Diego, CA (US)

(21) Appl. No.: 18/976,187

(22) Filed: Dec. 10, 2024

(51) Int. Cl. H04L 1/1812; G06F 12/02

(52) U.S. Cl. CPC H04L 1/1812; G06F 12/023

(57) ABSTRACT

An apparatus is configured to operate one of a pretrained or a pretrained and fine-tuned generative artificial intelligence (AI) foundation model (the generative AI foundation model), pretrained or pretrained and fine-tuned using at least a wireless language that models a wireless protocol, to receive a wireless input according to the wireless protocol, convert the wireless input into the wireless language, convert the wireless language into tokens, map each of the tokens to the generative AI foundation model as embeddings, capture patterns and relationships between the embeddings, expressed implicitly in statistics, using the generative AI foundation model, and apply the statistics, an output of the generative AI foundation model, or both to a dynamic memory management controller. The dynamic memory management controller adapts an amount of hybrid automatic repeat request (HARQ) buffer memory and/or logical channel buffer memory to allocate or release in the one or more memories.

### TECHNICAL FIELD

This disclosure relates generally to wireless communication and, more specifically, to hybrid automatic repeat request (HARQ) buffer memory and logical channel buffer memory usage and optimization employing generative artificial intelligence foundation models.

### INTRODUCTION

A user equipment (UE) (e.g., an apparatus, a scheduled entity, a wireless communication device, a mobile communication device, a sidelink entity) may have a finite amount (e.g., quantity) of memory. Some of that memory may be reserved as buffer space for HARQ processes and for logical channel data. For example, buffer space for logical channel data many be utilized at least because logical channel data may be received out-of-order and should be accumulated until the logical channel data can be mapped to upper layers in an in-order manner. In many examples, the amount of memory to reserve for HARQ processes and logical channel data has been determined based on worst-case scenarios. In these worst-case scenarios, a maximum amount of memory is reserved despite the low probability of needing that maximum amount and despite the probability of change based on several conditions including but not limited to: traffic pattern, user equipment (UE) conditions, settings, configurations, gNodeB (gNB) traffic load, gNB's scheduling algorithm and its fairness/responsiveness etc. Engineers and scientists are continually seeking ways to optimize memory allocations to improve memory reuse and efficiency of user equipment.

### BRIEF SUMMARY OF SOME EXAMPLES

The systems, methods, and devices of this disclosure each have several innovative aspects, no single one of which is solely responsible for the desirable attributes disclosed herein.

According to one example, an apparatus is described. The apparatus includes one or more memories and one or more processors coupled to the one or more memories. According to the example, the one or more processors are configured to, individually or collectively, based at least in part on information stored in the one or more memories: operate one of a pretrained or a pretrained and fine-tuned generative artificial intelligence (AI) foundation model (the generative AI foundation model), pretrained or pretrained and fine-tuned using at least a wireless language that models a wireless protocol, receive a wireless input according to the wireless protocol, convert the wireless input into the wireless language, convert the wireless language into tokens, map each of the tokens to the generative AI foundation model as embeddings, capture patterns and relationships between the embeddings, expressed implicitly in statistics, using the generative AI foundation model, and apply the statistics, an output of the generative AI foundation model, or both to a dynamic memory management controller. According to the example, the dynamic memory management controller adapts an amount of hybrid automatic repeat request (HARQ) buffer memory and/or logical channel buffer memory to allocate or release in the one or more memories.

In another example, an apparatus is described. The apparatus includes means for operating as a pretrained or a pretrained and fine-tuned generative artificial intelligence (AI) foundation model (the generative AI foundation model), pretrained or pretrained and fine-tuned using at least a wireless language that models a wireless protocol, means for receiving a wireless input according to the wireless protocol, means for converting the wireless input into the wireless language, means for converting the wireless language to tokens, means for mapping each of the tokens to the generative AI foundation model as embeddings, means for capturing patterns and relationships between the embeddings, expressed implicitly in statistics, using the generative AI foundation model, and means for applying the statistics, an output of the generative AI foundation model, or both to a dynamic memory management controller. According to the example, the dynamic memory management controller adapts an amount of hybrid automatic repeat request (HARQ) buffer memory and/or logical channel buffer memory to allocate or release in one or more memories.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a schematic illustration of an example of a wireless communication system according to some aspects of the disclosure.

FIG. 2 is a schematic illustration of an example of a radio access network according to some aspects of the disclosure.

FIG. 3 is an expanded view of an exemplary subframe, showing an orthogonal frequency division multiplexing (OFDM) resource grid according to some aspects of the disclosure.

FIG. 4 is a schematic depiction of a 5G user plane protocol stack and a 5G control plane protocol stack according to some aspects of the disclosure.

FIG. 5 is a schematic drawing of a mapping between logical channels, transport channels, and physical channels of a 5G NR system according to some aspects of the disclosure.

FIG. 6 is a block diagram representation of a system including a generative artificial intelligence (AI) foundation model circuit/function according to some aspects of the disclosure.

FIG. 7 is a block diagram illustrating an example of a hardware implementation of an apparatus employing one or more processing systems according to some aspects of the disclosure.

FIG. 8 is a flow chart illustrating an example process of flexible memory management at an apparatus in accordance with some aspects of the disclosure.

FIG. 9 is a flow chart illustrating an example process of flexible memory management at an apparatus in accordance with some aspects of the disclosure.

Like reference numbers and designations in the various drawings indicate like elements.

### DETAILED DESCRIPTION

The detailed description set forth below in connection with the appended drawings is directed to some particular examples for the purpose of describing innovative aspects of this disclosure. However, a person having ordinary skill in the art will readily recognize that the teachings herein can be applied in a multitude of different ways. Some or all of the described examples may be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system, or network that is capable of transmitting and receiving RF signals according to, but not limited to, one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple input multiple output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to persons having ordinary skill in the art that these concepts may be practiced without these specific details. In some examples, well-known structures and components are shown in block diagram form in-order to avoid obscuring such concepts.

While aspects and examples are described in this application by illustration to some examples, persons having ordinary skill in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein are examples of generative artificial intelligence (AI) foundation models and/or systems that may output predictions of realistic data (where the predicted data is predictive of the future), particularly data related to the operation and management of 3GPP compatible UEs, network entities, and their interactions. Each generative artificial intelligence (AI) foundation model may be pretrained (e.g., pretrained once) or pretrained and fine-tuned (i.e., pretrained and then fine-tuned). In one example, predictions of realistic downlink grant arrival times, burst arrival times, and burst durations may be obtained and may be used to reserve and optimize HARQ buffer memory allocation(s) and consequently enhance memory reuse across HARQ processes. HARQ buffer memory may be used to store HARQ processing, any associated intermediate state, artifacts, etc. necessary for successful (e.g., accomplishing its purpose, correct, complete) HARQ processing. HARQ buffer memory may be referred to herein as HARQ memory or HARQ buffer memory. The HARQ processes and the HARQ buffer memory used for the HARQ processing may be configured by firmware associated with Layer 2 (L2). In another example, predictions of realistic downlink grant arrival times, burst arrival times, burst durations, and block error rate (BLER) may be obtained and may be used to reserve and optimize logical channel buffer memory (referred to herein as logical channel memory or logical channel buffer memory) allocations in the upper layers (e.g., between the Internet Protocol (IP) layer (L3) and the application layer (L7)).

In accordance with aspects described herein, the exemplary pretrained or pretrained and fine-tuned generative AI foundation models and/or systems (which may be configured as circuits and described in terms of functions executed by circuits) may be configured at a UE or may be distributed (in any proportion) between the UE and a server with which the UE may communicate in real-time. Each generative AI foundation model may be a pretrained or a pretrained and fine-tuned generative AI foundation model. A given pretrained or pretrained and fine-tuned generative AI foundation model may be referred to hereinafter as the generative AI foundation model or the foundation generative link model.

Furthermore, the exemplary generative AI foundation models and/or systems described herein may be pretrained once, and may be fine-tuned in real-time, without need for much planning, often while the generative AI foundation model and/or system is operating with a particular network entity (e.g., on-the-fly) with a very small amount of data (very small in comparison to the amount of data used to originally train the generative AI foundation model and/or system), where the fine-tuning may enhance the performance of the pretrained or pretrained and fine-tuned generative AI foundation model and/or system with respect to predictions based on the operation of a given UE with the particular network entity.

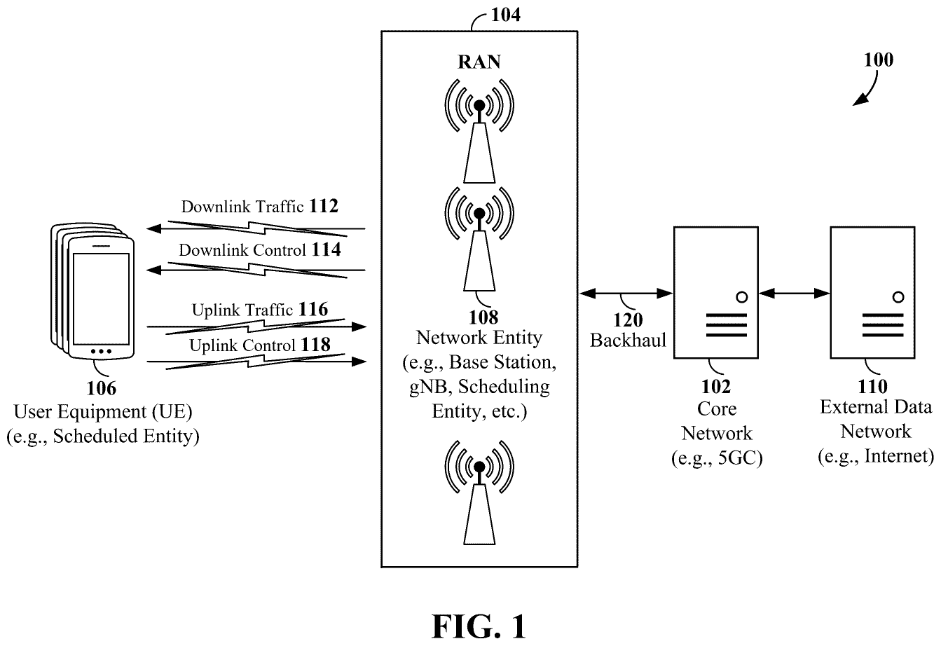

The various concepts presented throughout this disclosure may be implemented across a broad variety of telecommunication systems, network architectures, and communication standards. Referring now to FIG. 1, as an illustrative example without limitation, a schematic illustration of an example of a wireless communication system 100 according to some aspects of the disclosure is presented. The wireless communication system 100 includes three interacting domains: a core network 102, a radio access network (RAN) 104, and a user equipment (UE) 106 (e.g., of a plurality of UEs). By virtue of the wireless communication system 100, the UE 106 (e.g., an apparatus, a scheduled entity, a wireless communication device, a mobile communication device, a sidelink entity) may be enabled to carry out data communication with an external data network 110, such as, but not limited to, the Internet.

The RAN 104 may implement any suitable wireless communication technology or technologies to provide radio access to the UE 106. As one example, the RAN 104 may operate according to the 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN or NG-RAN. Of course, many other examples may be utilized within the scope of the present disclosure.

As illustrated, the RAN 104 includes a plurality of network entities 108. Broadly, a network entity 108 may be implemented in an aggregated or monolithic base station architecture or a disaggregated base station architecture and may include one or more of a central unit (CU), a distributed unit (DU), a radio unit (RU), a Near-Real-time (Near-RT) RAN Intelligent Controller (RIC), or a Non-Real-time (Non-RT) RIC. In some examples, a network entity 108 may be a network element in a radio access network responsible for radio transmission and reception in one or more cells to or from a UE. In different technologies, standards, or contexts, the network entity 108 may variously be referred to by persons having ordinary skill in the art as a base transceiver station (BTS), a radio base station, a base station, a radio transceiver, a transceiver function, a basic service set (BSS), an extended service set (ESS), an access point (AP), a Node B (NB), an eNode B (eNB), a gNode B (gNB), a transmission and reception point (TRP), a scheduling entity, a network access point, or some other suitable terminology. In some examples, a network entity 108 may include two or more TRPs that may be collocated or non-collocated. Each TRP may communicate on the same or different carrier frequency within the same or different frequency band. In examples where the RAN 104 operates according to both the LTE and 5G NR standards, one of the network entities may be an LTE network entity, while another network entity may be a 5G NR network entity.

The RAN 104 is further illustrated as supporting wireless communication for multiple mobile apparatuses, one of which may be identified as UE 106. A mobile apparatus may be referred to as user equipment (UE) in 3GPP standards, but may also be referred to by persons having ordinary skill in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, a scheduled entity, or some other suitable terminology. The UE 106 may be an apparatus (e.g., a mobile apparatus, a wireless communication device) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smartphone, a session initiation protocol (SIP) phone, a laptop, a personal computer (PC), a notebook, a smartbook, a tablet, a personal digital assistant (PDA), and a broad array of embedded systems, e.g., corresponding to an “Internet of Things” (IoT).

A mobile apparatus (e.g., UE 106) may additionally be an automotive or other type of transportation vehicle, a remote sensor or actuator, a robot or robotics device, a satellite radio, a global positioning system (GPS) device, an object tracking device, a remote control device, a consumer and/or wearable device, such as eyewear, a wearable camera, a virtual reality device, a smartwatch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide and/or facilitate connected medicine or telemedicine support (e.g., health care at a distance, also referred to as telehealth). Telehealth devices may include telehealth monitoring devices and telehealth administration devices, whose communication may be given preferential treatment or prioritized access over other types of information, for example, in terms of prioritized access for transport of critical service data and/or relevant QoS for transport of critical service data.

Wireless communication between the RAN 104 and the UE 106 may be described as utilizing an air interface. Transmissions over the air interface from a network entity (e.g., similar to network entity 108) to one or more UEs (e.g., similar to UE 106) may be referred to as downlink (DL) transmission. In accordance with certain aspects of the present disclosure, the term downlink may refer to a point-to-multipoint transmission or a point-to-point transmission (e.g., groupcast, multicast, or unicast) originating at a network entity (e.g., network entity 108). Another way to describe this scheme may be to use the term broadcast channel multiplexing. Transmissions from a UE (e.g., UE 106) to a network entity (e.g., network entity 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, where a network entity (e.g., a network entity 108) allocates resources for communication among some or all devices and equipment within its service area or cell. Within the present disclosure, as discussed further below, the network entity (e.g., network entity 108) may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the network entity 108.

Network entities 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, the network entity 108 may broadcast downlink traffic 112 (also referred to as downlink data traffic) to one or more UEs 106. Broadly, the network entity 108 may be a node or device responsible for scheduling traffic (e.g., data traffic, user data traffic) in a wireless communication network, including the downlink traffic 112 and, in some examples, uplink traffic 116 (also referred to as uplink data traffic) from one or more UEs 106 to the network entity 108. On the other hand, the UE 106 (e.g., the scheduled entity) may be a node or device that receives downlink control 114 information, including but not limited to scheduling information (e.g., a grant), synchronization or timing information, or other control information from another entity in the wireless communication network such as the network entity 108. The UE 106 may further transmit uplink control 118 information, including but not limited to a scheduling request, feedback information, or other control information, to the network entity 108.

In addition, the uplink control 118 information and/or downlink control 114 information and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required; any suitable scheme for organizing waveforms may be utilized, and various time divisions of the waveform may have any suitable duration.

In general, the network entity 108 may include a backhaul interface (not shown) for communication with a backhaul portion 120 of the wireless communication system 100. The backhaul portion 120 may provide a link between a network entity 108 and the core network 102. Further, in some examples, a backhaul network may provide interconnection between respective network entities 108. Various types of backhaul interfaces may be employed, such as a direct physical connection, a virtual network, or the like, using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC) or any other suitable standard or configuration.

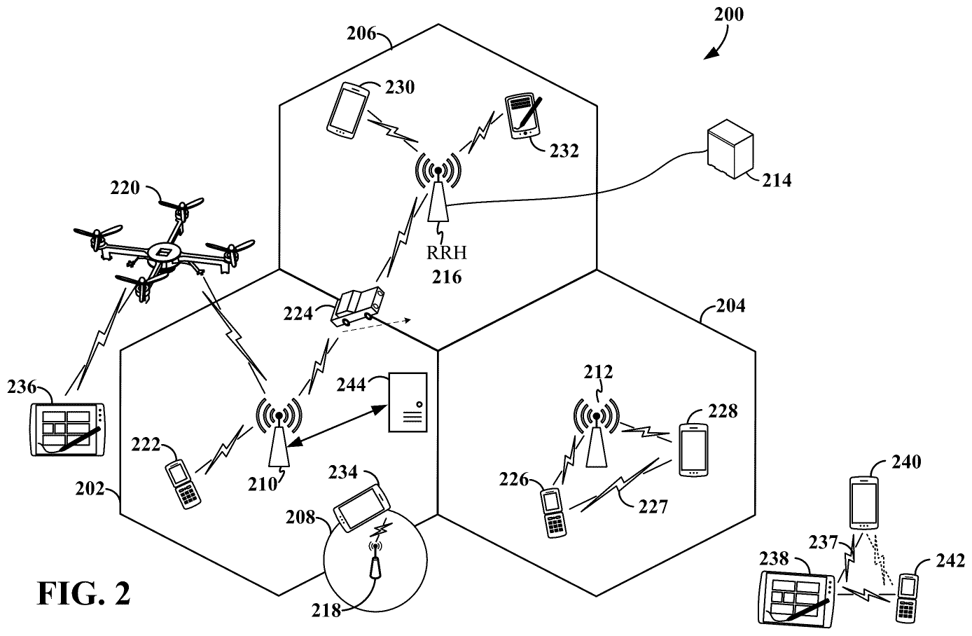

Referring now to FIG. 2, as an illustrative example without limitation, a schematic illustration of an example of a radio access network (RAN) 200 according to some aspects of the disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or network entity. FIG. 2 illustrates cells 202, 204, 206, and 208, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas, with each antenna responsible for communication with UEs in a portion of the cell.

Various network entity arrangements can be utilized. For example, in FIG. 2, two network entities, referred to as base station 210 and base station 212, are shown in cells 202 and 204. A third network entity, referred to as base station 214, is shown controlling a remote radio head (RRH) 216 in cell 206. That is, a network entity can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of network entities (e.g., base stations, gNBs, TRPs, scheduling entities) and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, 218 may be the same as or similar to the network entity 108 described above and illustrated in FIG. 1.

FIG. 2 further includes a mobile network entity 220. The mobile network entity 220 may be configured to function as a base station or, more specifically, as a mobile base station. That is, in some examples, a cell may not necessarily be stationary, and the geographic area of the cell may move according to the location of a mobile base station, such as the mobile network entity 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210, UEs 226 and 228 may be in communication with base station 212, UEs 230 and 232 may be in communication with base station 214 by way of RRH 216, UE 234 may be in communication with base station 218, and UE 236 may be in communication with mobile base station 220. In some examples, the UEs 222, 224, 226, 228, 230, 232, 234, 236, 238, 240, 242 may be the same as or similar to the one or more UEs 106 described above and illustrated in FIG. 1. In some examples, the mobile base station 220 may be a mobile network entity and may be configured to function as a UE. For example, the mobile network entity 220 may operate within cell 202 by communicating with base station 210. Also depicted is a server 244 that may be in real-time communication with UE 222 and/or UE 224 via the network entity 210. Of course, the server 244 need not be in the same cell 202 as UE 222 and/or UE 224 to be in real-time communication with those UEs.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or another suitable sidelink network. For example, two or more UEs (e.g., UEs 238, 240, 242) may communicate with each other using sidelink signals 237 without relaying that communication through a base station. In some examples, the UEs 238, 240, 242 may each function as a scheduling entity or transmitting sidelink device and/or a scheduled entity or a receiving sidelink device to schedule resources and communicate sidelink signals 237 therebetween without relying on scheduling or control information from a base station (e.g., a network entity). In other examples, two or more UEs (e.g., UEs 226, 228) within the coverage area of a network entity (e.g., base station 212) may also communicate sidelink signals 227 over a direct link (sidelink) without conveying that communication through the network entity (e.g., base station 212). In this example, the base station 212 may allocate resources to UE 226 and UE 228 for the sidelink communication.

In order for transmissions over the air interface to obtain a low block error rate while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. The exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding based on nested sequences. Puncturing, shortening, and repetition may be used for rate matching in these channels.

Aspects of the present disclosure may be implemented utilizing any suitable channel code. Various implementations of network entities and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a network entity (e.g., an aggregated or disaggregated base station, gNB, eNB, TRP, scheduling entity, etc.), or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another or if the signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell (e.g., cell 202) to the geographic area corresponding to a neighboring cell (e.g., cell 206). When the signal strength or quality from the neighboring cell exceeds that of its serving cell for a given amount of time, the UE 224 may transmit a reporting message to its serving network entity (e.g., base station 210), indicating this condition. In response, the UE 224 may receive a handover command, and the UE may undergo a handover to the neighboring cell (e.g., cell 206).

In a network configured for UL-based mobility, UL reference signals from each UE may be utilized by the network to select a serving cell for each UE. In some examples, the base stations 210, 212, 214/216 may broadcast unified synchronization signals (e.g., unified Primary Synchronization Signals (PSSs), unified Secondary Synchronization Signals (SSSs), and unified Physical Broadcast Channels (PBCHs)). The UEs 222, 224, 226, 228, 230, 232 may receive the unified synchronization signals, derive the carrier frequency and slot timing from the synchronization signals, and, in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, 214/216 may be unified, the synchronization signal may not identify a particular cell but rather may identify a zone of multiple cells operating on the same frequency and/or with the same timing. The use of zones in 5G networks or other next-generation communication networks enables the uplink-based mobility framework and improves the efficiency of both the UE and the network, at least because the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for the exclusive use of a portion of the spectrum, generally by virtue of a mobile network operator purchasing a license from a government regulatory body. Unlicensed spectrum provides for the shared use of a portion of the spectrum without the need for a government-granted license. While compliance with some technical rules is generally still required to access unlicensed spectrum, generally, any operator or device may gain access. Shared spectrum may fall between licensed and unlicensed spectrum, where technical rules or limitations may be required to access the spectrum, but the spectrum may still be shared by multiple operators and/or multiple radio access technologies (RATs). For example, the holder of a license for a portion of a licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may be within FR2, FR4, FR4-a, FR4-1, and/or FR5 or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210 and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, and by example, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated to transmissions in one direction, while at other times, the channel is dedicated to transmissions in the other direction, where the direction may change very rapidly, e.g., several times per slot. In a wireless link, a full-duplex channel generally relies on the physical isolation between a transmitter and receiver, as well as suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within a paired spectrum). In SDD, transmissions in different directions on a given channel are separated from one another using spatial division multiplexing (SDM). In other examples, full-duplex communication may be implemented within an unpaired spectrum (e.g., within a single carrier bandwidth), where transmissions in different directions occur within different subbands of the carrier bandwidth. This type of full-duplex communication may be referred to herein as subband full-duplex (SBFD), also known as flexible duplex.

Deployment of communication systems, such as 5G new radio (NR) systems, may be arranged in multiple manners with various components or constituent parts. In a 5G NR system or network, a network entity, a mobility element of a network, a radio access network (RAN) node, a core network entity, a network element, or a network equipment, such as a base station (BS), or one or more units (or one or more components) performing base station functionality, may be implemented in an aggregated or disaggregated architecture. For example, a BS (such as a Node B (NB), evolved NB (eNB), gNB, NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU can also be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

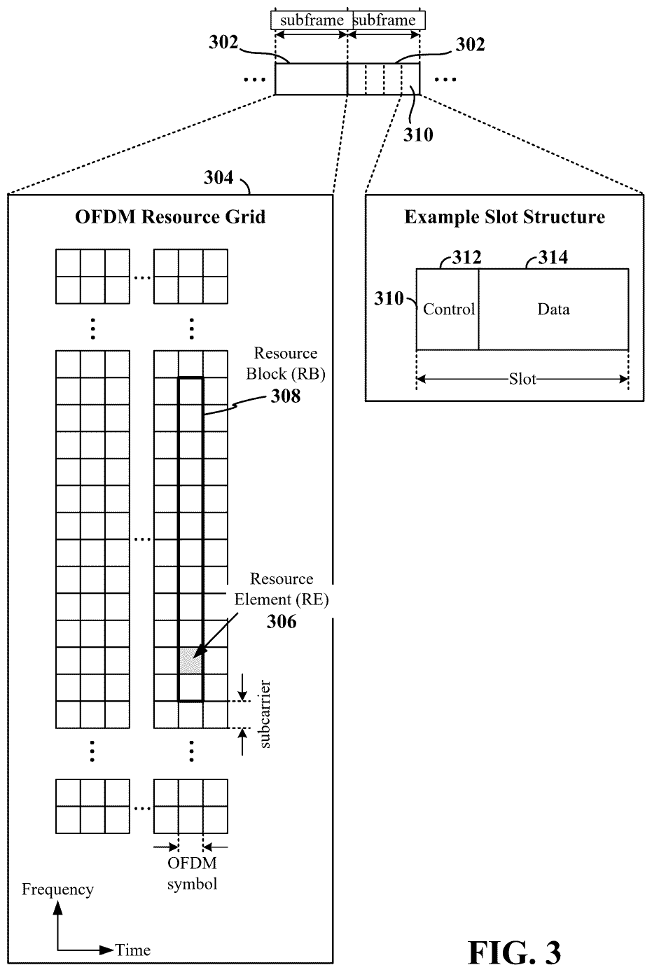

Various aspects of the present disclosure will be described with reference to an OFDM waveform, schematically illustrated in FIG. 3. It should be understood by persons having ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied to SC-FDMA waveforms as well.

Referring now to FIG. 3, an expanded view of an exemplary subframe 302 is illustrated, showing an OFDM resource grid. However, as persons having ordinary skill in the art will readily appreciate, the physical (PHY) transmission structure for any particular application may vary from the example described here, depending on any number of factors. Here, time is in the horizontal direction with units of OFDM symbols, and frequency is in the vertical direction with units of subcarriers of the carrier.

The resource grid 304 may be used to schematically represent time-frequency resources for a given antenna port. That is, in a multiple input multiple output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid and contains a single complex value representing data from a physical channel or signal. Depending on the modulation utilized in a particular implementation, each RE may represent one or more bits of information. In some examples, a block of REs may be referred to as a physical resource block (PRB) or, more simply, a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), subband, or bandwidth part (BWP). A set of subbands or BWPs may span the entire bandwidth. Scheduling of wireless communication devices (e.g., V2X devices, sidelink devices, or other UEs, hereinafter generally referred to as UEs) for downlink, uplink, or sidelink transmissions may involve scheduling one or more resource elements 306 within one or more subbands or bandwidth parts (BWPs). Thus, a UE generally utilizes only a subset of the resource grid 304. In some examples, an RB may be the smallest unit of resources that can be allocated to a UE. Thus, the more RBs scheduled for a UE and the higher the modulation scheme chosen for the air interface, the higher the data rate for the UE. The RBs may be scheduled by a network entity (e.g., an aggregated or disaggregated base station, gNB, eNB, TRP, scheduling entity, etc.) or may be self-scheduled by a UE/sidelink device implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. An additional example may include mini-slots, sometimes referred to as shortened transmission time intervals (TTIs), having a shorter duration (e.g., one to three OFDM symbols). These mini-slots or shortened transmission time intervals (TTIs) may, in some cases, be transmitted and may occupy resources scheduled for ongoing slot transmissions for the same or different UEs. Any number of resource blocks may be utilized within a subframe or slot.

An expanded view of slot 310 illustrates that the slot 310 includes a control region 312 and a data region 314. In general, the control region 312 may carry control channels, and the data region 314 may carry data channels. In some examples, a Uu slot (e.g., slot 310) may contain all DL, all UL, or at least one DL portion and at least one UL portion. The structures illustrated in FIG. 3 are merely exemplary in nature, and different slot structures may be utilized and may include one or more of each of the control region(s) and data region(s).

Although not illustrated in FIG. 3, the various REs 306 within the RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a network entity, UE, or another similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the network entity may allocate one or more REs 306 (e.g., within the control region 312) of the slot 310 to carry DL control information, including one or more DL control channels, such as a physical downlink control channel (PDCCH), to one or more UEs (e.g., scheduled entities). The PDCCH carries downlink control information (DCI), including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to persons having ordinary skill in the art, where the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 306 (e.g., in the control region 312 or the data region 314) of the Uu slot 310 to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 4, 10, 20, 50, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (MSI) for initial access. Examples of system information transmitted in the MIB may include but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include but are not limited to, a random access search space, a paging search space, downlink configuration information, and uplink configuration information. A network entity may transmit other system information (OSI) as well.

In an UL transmission, the UE (e.g., scheduled entity) may utilize one or more REs 306 of the Uu slot 310 to carry UL control information (UCI), including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., a request for the scheduling entity to schedule uplink transmissions. In response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI.

In addition to control information, one or more REs 306 (e.g., within the data region 314) of the Uu slot 310 may be allocated for data traffic. Such data traffic may be carried on one or more traffic channels, such as, for a DL transmission, a physical downlink shared channel (PDSCH), or for a UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a PC5 interface, the control region 312 of the slot 310 may include a physical sidelink control channel (PSCCH), including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH), including sidelink data traffic transmitted by the initiating (transmitting) sidelink device within resources reserved over the sidelink carrier by the transmitting sidelink device via the SCI. Other information may further be transmitted over various REs 306 within slot 310. For example, sidelink MAC-CEs may be transmitted in the data region 314 of the slot 310. In addition, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS), may be transmitted within the slot 310.

The physical channels described above are generally multiplexed and mapped to transport channels for handling at the medium access control (MAC) layer. Transport channels carry blocks of information called transport blocks (TB). The transport block size (TBS), which may correspond to a number (e.g., an amount, a quantity) of bits of information, may be a controlled parameter based on the modulation and coding scheme (MCS) and the number of RBs in a given transmission.

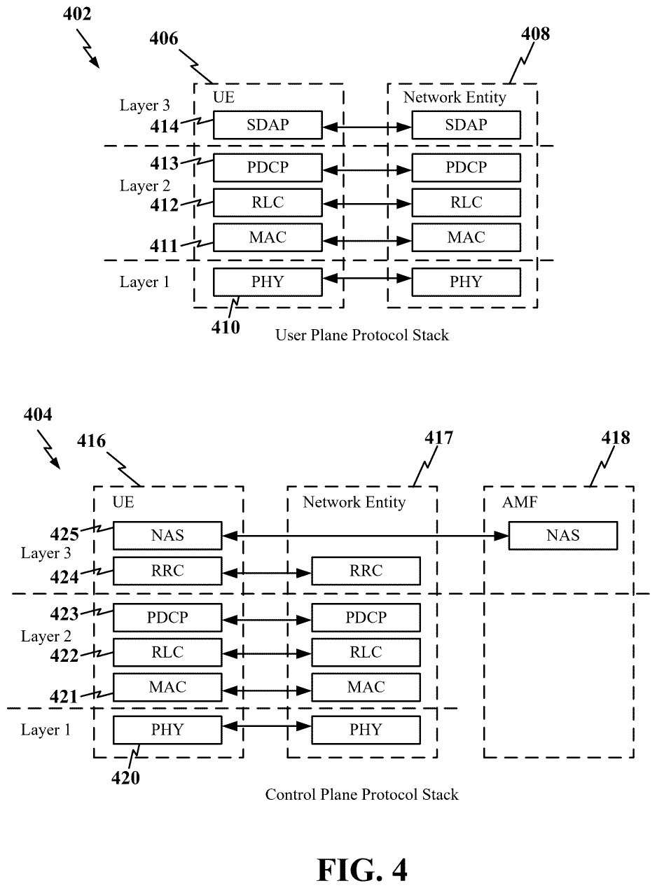

FIG. 4 is a schematic depiction of a 5G user plane protocol stack 402 and a 5G control plane protocol stack 404 according to some aspects of the disclosure. The functions of each of the layers are well known and will not be described herein for the sake of brevity.

The user plane protocol stack 402 depicts a first protocol stack 406 of a UE (e.g., a scheduled entity) and a second protocol stack 408 of a network entity (e.g., a scheduling entity). The first and second protocol stacks include the following layers: physical (PHY) 410, medium access control (MAC) 411, radio link control (RLC) 412, packet data convergence protocol (PDCP) 413, and service data adaptation protocol (SDAP) 414. With reference to layers of a numbered layer protocol stack model, the PHY 410 layer may occupy Layer 1 (L1), the MAC 411, RLC 412, and PDCP 413 layers may occupy Layer 2 (L2), and the SDAP 414 layer may occupy Layer 3 (L3). According to some aspects, L1 may be referred to as the physical layer and L2 may be referred to as the data link layer.

The control plane protocol stack 404 depicts a third protocol stack 416 of the UE, a fourth protocol stack 417 of the network entity, and a fifth protocol stack 418 of an access and mobility management function (AMF). The third protocol stack 416 of the UE and the fourth protocol stack 417 of the network entity include the following layers: PHY 420, MAC 421, RLC 422, PDCP 423, and radio resource control (RRC) 424. The third protocol stack 416 of the UE and the fifth protocol stack 418 of the AMF include a non-access stratum (NAS) 425 layer. With reference to layers of a numbered layer protocol stack model, the PHY 420 layer may occupy Layer 1 (L1), and the MAC 421, RLC 422, and PDCP 423 layers may occupy Layer 2 (L2). The NAS 425 layer may occupy Layer 3 (L3).

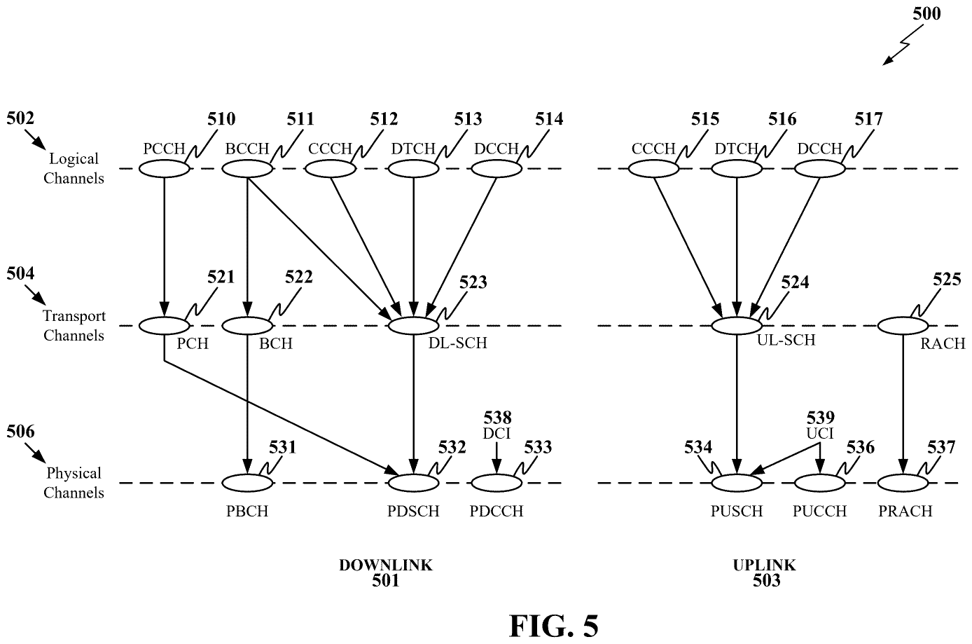

FIG. 5 is a schematic drawing of a mapping 500 between the logical channels 502, the transport channels 504, and the physical channels 506 of a 5G NR system according to some aspects of the disclosure. The functions of each channel throughout the logical channels 502, the transport channels 504, and the physical channels 506 are well known and will not be described herein for the sake of brevity.

The logical channels 502 link the RLC layer (e.g., RLC 412 in the user plane and RLC 422 in the control plane of FIG. 4) to the MAC layer (e.g., MAC 411 in the user plane and MAC 421 in the control plane of FIG. 4). In the downlink 501 direction, data may be received at the RLC layer and mapped to logical channels 502. There are five logical channels in the downlink 501 direction: the Paging Control Channel (PCCH) 510, Broadcast Control Channel (BCCH) 511, the Common Control Channel (CCH) 512, the Dedicated Traffic Channel (DTCH) 513, and the Dedicated Control Channel (DCCH) 514. There are three logical channels in the uplink 503 direction: the Common Control Channel (CCH) 515, the Dedicated Traffic Channel (DTCH) 516, and the Dedicated Control Channel (DCCH) 517.

From the RLC layer (e.g., RLC 422 of FIG. 4) the logical channels 502 are mapped to transport channels 504 in the MAC layer. Data at in the transport channels 504 is packaged in transport blocks (TBs). There are three transport channels 504 in the downlink 501 direction: the Paging Channel (PCH) 521, the Broadcast Channel (BCH) 522, and the Downlink-Shared Channel (DL-SCH) 523. There are two transport channels 504 in the uplink 503 direction: the Uplink-Shared Channel (UL-SCH) 524, and the Random Access Shared Channel (RACH) 525.

From the MAC layer (e.g., MAC 421 of FIG. 4) the transport channels 504 are mapped to physical channels 506 at the Physical (PHY) layer (e.g., PHY 410 in the user plane and PHY 420 in the control plane of FIG. 4). The physical channels 506 are transmitted/received over the air. There are three physical channels 506 in the downlink 501 direction: the Physical Broadcast Channel (PBCH) 531, the Physical Downlink Shared Channel (PDSCH) 532, and the Physical Downlink Control Channel (PDCCH) 533. Downlink Control Information (DCI) 538 may be carried over the PDCCH 533 in the physical channels 506. There are three physical channels 506 in the uplink 503 direction: the Physical Uplink Shared Channel (PUSCH) 534, the Physical Uplink Control Channel (PUCCH) 536, and the Physical Random Access Channel (PRACH) 537. Uplink Control Information (UCI) 537 may be carried over the PUSCH 534 and the PUCCH 536.

The channels, carriers, and layers of protocol stacks, logical, transport, and physical channels described above in connection with FIGS. 1-5 are not necessarily all of the channels, carriers, and layers of protocol stacks, logical, transport, and physical channels that may be utilized between devices (e.g., UEs and network entities) and persons having ordinary skill in the art will recognize that other channels, carriers, or layers may be utilized in addition to those illustrated.

Described herein are examples of a generative AI foundation model (configured as a circuit and/or function) that may be used to optimize HARQ buffer memory allocations and logical channel buffer memory allocations at a UE, and thereby reduce wasteful allocations of memory space that is unlikely to be used in connection with actual operation/use of the HARQ buffer memory space and logical channel buffer memory space allocated at the UE. The generative AI foundation model and/or associated circuits/functions may be located in whole at a UE, distributed between a UE and a server in real-time communication with the UE, or in whole at the server (in which case the UE may effectively serve as a client of the generative AI foundation model system at the server). In other words, in an instance where the generative AI foundation model system 600 is configured as an apparatus, the apparatus may be a user equipment, a server in real-time communication with the user equipment, or may be distributed between the user equipment and the server.

The generative AI foundation model may be used to simulate a realistic future by considering the recent past. The generative AI foundation model may be used in an autoregressive prediction fashion (also referred to as autoregressive generation) in which, once prompted, the generative AI foundation model generates a prediction of a realistic future token sequence, and the generative AI foundation model generates a distribution over each generated next token. The generative AI foundation model may select the next token based on the generated distribution, appends the selected next token to the prompt, and repeats the prompting process for the next sequential moment in time (next sequential token). Thus, the output of the generative AI foundation model may be fed back to it as input in the next subsequent operation.

The generative AI foundation model may operate on a token-by-token basis or a slot-by-slot basis, for example, where each slot may be converted into a set of tokens in a specific order. For example, the generative AI foundation model may provide the predicted downlink grant arrival times, the predicted burst durations, the predicted burst arrival times, or the predicted block error rate on a token-by-token basis or a slot-by-slot basis. Any aggregated/derived future quantities, such as downlink grant arrival time, throughput, or block error rate, may be calculated by generating a set of possible futures and obtaining the required statistics based on the set of possible futures.

According to some aspects described herein, the generative AI foundation model may be used at the UE side to predict realistic future downlink grant arrival times, burst durations, burst arrival times, and BLER, and such predictions may be used to optimize HARQ buffer memory allocation and enhance memory reuse across HARQ processes. In some examples, the HARQ processes and the memory used by the HARQ processes may be configured by firmware used to configure the L2 layer. According to some aspects described herein, the generative AI foundation model may be used at the UE side to predict realistic future downlink grant arrival times, burst durations, burst arrival times, and block error rate, and such predictions may be used to reserve and optimize logical channel buffer memory allocation in the upper layers (e.g., in the layers between the IP layer (L3) and the application layer (L7)). According to some aspects, these predictions may be made by responding to a prompt, which may be presented in a “wireless” language (described below).

As used herein, a burst may be understood as a flurry of grants separated at least by a constant duration.

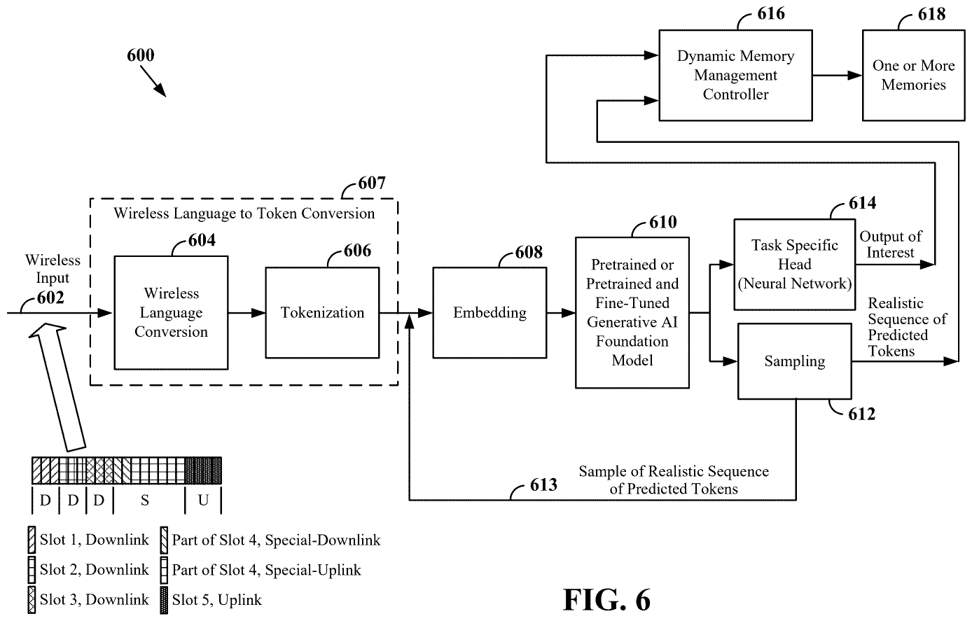

As used herein the term “UE side” may be a reference to a UE alone or a UE and an associated server with which the UE may communicate in real-time. In this aspect, the generative AI foundation model and associated circuits/functions may be located and operating (e.g., executing) at the associated server as shown and described in connection with the generative AI foundation model or system, such as the exemplary generative AI foundation model system 600 of FIG. 6. Such an exemplary system may require more space and/or more processing power than a UE has available. In a configuration where the UE operates in real-time communication with the server, the UE may act as an interface to the server and to the generative AI foundation model system configured there.

In some examples, the generative AI foundation model system may exhibit a downlink grant prediction over a future horizon (e.g., over a future horizon of a given number of slots). In some examples, the generative AI foundation model system may predict realistic future block error rate given a limited past (e.g., a limited past of a given number of slots). With such knowledge, instead of blindly allocating the maximum amount of memory space according to a 3GPP specification, the UE can reserve HARQ buffer memory and logical channel buffer memory based on predictions of downlink grant arrival time, burst duration, burst arrival time, and/or predicted block error rate values. In other words, the UE, by using the generative AI foundation model system may gain (predicted) a priori knowledge that informs the allocation of HARQ buffer memory and logical channel buffer memory in the UE.

FIG. 6 is a block diagram representation of a generative AI foundation model system 600 including a generative AI foundation model circuit/function that was pretrained or pretrained and fine-tuned (referred to hereinafter as the generative AI foundation model 610) according to some aspects of the disclosure. By way of example, the generative AI foundation model 610 may be pretrained and, as deployed or used, it may be optionally fine-tuned (e.g., before deployment or use). The term “foundation model” may be used to describe a deep learning model that may be pretrained on an amount of data from a variety of different contexts. The amount of data may be represented as multiple datasets and may be referred to as datasets or wireless language datasets herein.

The generative AI foundation model 610 may be adapted (e.g., fine-tuned) to specific contexts (where, in some examples, the specific context may be thought of as a specific scenarios). Each specific context may be associated with an amount (e.g., a quantity) of data that is pertinent to the specific context and smaller than the amount of data used to initially pretrain the generative AI foundation model 610.

As used herein, a “context” may refer to the information that informs the generative AI foundation model 610 and facilitates the generation of output from the generative AI foundation model 610. Some aspects of the term “context” may include, but are not limited to, the one or more datasets used to train the context, which informs the output of the generative AI foundation model 610. Another aspect of context may be its relevance and coherence. Relevance may be understood as the applicability of the context to the problem being solved or the prediction being made by the generative AI foundation model 610. Coherence may be described as the degree to which the generative AI foundation model 610 is able to generate output that is logical (within a framework of the context) and presented as a series of ideas that are consistently connected. By way of example, according to some aspects of the disclosure, the aspects of relevance and coherence together may mean: scenario recognition and realistic future prediction. Another aspect of context may be the degree to which the generative AI foundation model 610 is able to keep its output pertinent and accurate in the face of continual change of its input. Here the changes to the input may be associated with, among other things, changes in the content of the streams of wireless communication that may flow, possibly in both directions, between a UE and a network entity.

Other changes to input may include changes in prompts and queries presented to (e.g., input to) the generative AI foundation model 610. As used herein, a “prompt” may be a string of input provided to the generative AI foundation model 610 (or its underlying large language model (LLM)), which effectively asks the generative AI foundation model 610 (or its underlying LLM) to generate a distribution over a next token in a sequence of predicted tokens output by (e.g., output from) the generative AI foundation model 610. The word “prompting” may refer to the act of inputting a prompt to the system. Another aspect of context may relate to an ability of the generative AI foundation model 610 to gauge a user's intent in view of receiving new input data and new prompts and/or queries from the user. The generative AI foundation model 610 may continually gauge the user's intent to maintain the relevancy of the output of the generative AI foundation model 610. This continual gauging may be done implicitly through the wireless token language.

The generative AI foundation model 610 may be based on a large language model (LLM). The LLM may be a specific type of foundation model upon which the generative AI foundation model 610 is constructed. According to some aspects, the generative AI foundation model 610 may be based on an LLM trained with “tokens” derived from wireless language dataset(s). Here, the term wireless language refers to a language that represents one or more of: wireless signals, configurations, settings, values, and/or fields represented by the wireless signals, configurations, and/or the settings, associated conditions at either the UE (i.e., the apparatus) or a network entity, or user intent, etc. (individually or in any combination referred to as wireless input 602 herein).

The wireless input 602 may be present in downlink traffic and/or downlink control (such as downlink traffic 112 and/or downlink control 114) and/or present in uplink traffic and/or uplink control (such as uplink traffic 116 and/or uplink control 118), all as shown and described in connection with FIG. 1. The wireless input 602 may be exchanged between a UE (such as UE 106) and/or a network entity (such as network entity 108). The wireless input may also represent settings or parameters known to (e.g., configured, understood by, recognized by) the UE that are not explicitly signaled to the UE but known by the UE.

The generative AI foundation model system 600 may include a wireless language conversion 604 circuit configured to convert the wireless input 602 into the wireless language. In some examples, the wireless language may represent one or more wireless protocols, such as, by way of example and not limitation, any standardized wireless protocol such as any wireless protocol standardized currently or in the future by the Third Generation Partnership Project (3GPP) (e.g., 3GPP 5G NR wireless protocol or a forthcoming 6G wireless protocol) or the Institute of Electrical and Electronics Engineers (IEEE). The wireless language may be referred to as a wireless interface language as it primarily models the UE-network entity (e.g., UE-gNB) air interface communication protocols. In some examples, the wireless language may describe past link level activity or hypothetical future activity. In the example of FIG. 6, the wireless input 602 is graphically represented as a plurality of downlink (D), special(S), and uplink (U) slots. The special slots may include both downlink and uplink portions. Other representations of the wireless input 602 are within the scope of the disclosure. The language can be used to represent any TDD slot configuration.

The generative AI foundation model system 600 may include a tokenization 606 circuit/function. The tokenization 606 circuit/function may be configured to convert the wireless language into tokens.

at least some tokens may be understood as elements that correspond to at least one of: a signal, a value, or a field of a given parameter (e.g., a field of an information element) utilized by a UE and/or a network entity (e.g., a gNB) within a context that is the subject upon which a prediction (or some other result) may be made. In some examples, the at least one of: a signal, a value, or a field of a given parameter may be obtained from data at a slot, resource block, and/or resource element level.

Of course, the wireless language conversion 604 circuit/function and the tokenization 606 circuit/function could be merged into one circuit/function that may be referred herein as a wireless language to token conversion 707 circuit/function as depicted in dashed line in FIG. 6. Accordingly, the wireless language to token conversion 707 circuit/function may be described as a circuit/function that converts the wireless input 602 into tokens.

The generative AI foundation model system 600 may include an embedding circuit/function 608. As used herein, an “embedding” may be an encoded representation of a particular (tokenized) setting or characteristic at the UE or the network entity (e.g., an encoded representation of a signal, value, and/or field) and may additionally or alternatively be an encoded representation of past link level activity or a hypothetical future outcome (generally represented by the wireless input 602). For example, a network entity setting (such as a BLER Target or a Band) can be fingerprinted into an embedding. Similarly, a UE side setting such as a Frame Pattern, a Quality of Service (QoS) Profile, or an Application Traffic Profile may be represented as an embedding. The preceding lists are exemplary and non-limiting.

Table 1 below provides one example of tokens relative to embeddings. For the sake of brevity, only the first row of Table 1 will be described. A person having ordinary skill in the art will understand how to apply the example of the first row of Table 1 to the examples in the other rows of Table 1.

TABLE 1
TOKENS AND EMBEDDINGS

| Token ID | Embedding |
|---|---|
| CQI0 | A |
| CQI1 | B |
| . . . | . . . |
| DL Rank 1 | X |
| DL Rank 2 | Y |
| . . . | . . . |

As illustrated in the first row, “CQI0” is the identifier of the first token. CQI0 represents one Channel Quality Indicator (CQI) (whose index is 0). A UE may report a CQI to a network entity in a physical uplink control channel. The CQI allows the UE to provide feedback to the network entity on the downlink channel quality. The UE calculates the CQI based on measurement of a channel state information reference signal (CSI-RS). Once calculated, the CQI is presented as an index value representing downlink channel quality within a stream of data similar to the stream of slots representing wireless input 602. The CQI value may be used by the network entity to inform the network entity regarding downlink scheduling and downlink resource allocation. In this example, the tokenization 606 circuit/function may convert the CQI value to a token (i.e., may tokenize the CQI value); the embedding circuit/function 608 may map the token to high-dimensional vectors that may be applied to the generative AI foundation model 610.

According to some aspects, the generative AI foundation model 610 may use past link level activity (e.g., wireless input 602) such as Downlink (DL) Rank, Modulation and Coding Scheme (MCS), Number of Resource Elements (REs) from DL grant, Uplink (UL) Channel State Feedback (CSF) reports, HARQ ACK/NACK and may optionally use a hypothetical future to output a realistic sequence of predicted tokens. In some examples, the realistic sequence of predicted tokens may be predicted on a slot-by-slot or a token-by-token basis. According to some aspects, the generative AI foundation model system 600 output may be on a token-by-token basis, where the tokens map to slots.

According to some examples, a generative AI foundation model system 600, pretrained or pretrained and fine-tuned using at least a language that models a wireless protocol, may receive wireless input 602 according to the wireless protocol, convert the wireless input 602 to tokens, map each of the tokens to the generative AI foundation model using embeddings, capture patterns and relationships between the embeddings, expressed implicitly in statistics, using the generative AI foundation model, and output a sequence of predicted tokens based on the patterns and relationships between the embeddings, the sequence of predicted tokens including at least one of: a predicted downlink grant arrival time, a predicted burst duration, a predicted burst arrival time, or a predicted block error rate.

According to some aspects, the generative AI foundation model 610 may be used to predict at least one of: a downlink grant arrival time, a burst duration, a burst arrival time, or a block error rate. Upon the occurrence of the generative AI foundation model 610 predicting at least the downlink grant arrival time, the generative AI foundation model 610 may also predict the downlink rank, MCS, and grant size.

The generative AI foundation model 610 may receive feedback via a feedback path 613. The feedback may be provided by a sampling 612 circuit/function. The feedback path 613 may originate at an output of the sampling 612 circuit/function and terminate at the input of the embedding circuit/function 608. Using such a feedback path 613, the generative AI foundation model 610 may use its own prediction (e.g., a token from a realistic sequence of predicted tokens) and an original input prompt each time it makes the next future prediction. The type of prediction, which employs the feedback substantially as shown and described in connection with FIG. 6 may be referred to as an autoregressive prediction (or autoregressive generation) as described above.

Rather than obtaining an output generated using autoregressive prediction from the sampling 612 circuit/function, an output generated using a neural network may be obtained from a task specific head 614. The term “task specific head” as used herein may be a refence to a neural network layer (e.g., a multilayer perception (MLP) layer) added on top of (or at the output of) the generative AI foundation model 610 to predict an amount of interest other than the next token (where the next token is the default target).

As described above, an act of prompting may refer to the act of providing a string of input to the embedding circuit/function 608. According to some aspects, the act of providing the string of input may cause the generative AI foundation model 610 (e.g., the LLM) to generate a distribution over the next token (in the realistic sequence of predicted tokens). According to the aspect of autoregressive prediction (or autoregressive generation), once the embedding circuit/function 608 receives a prompt, the generative AI foundation model 610 may generate a distribution (e.g., a probability distribution) over the next token. The generative AI foundation model 610 selects the next token based on this distribution and appends the next token to the prompt (e.g., to the input of the wireless language conversion 604 circuit/function, whose output is tokenized by the tokenization 606 circuit/function and input to the generative AI foundation model 610 circuit/function as embeddings output from the embedding circuit/function 608) and repeats the prompting process for a next time/iteration (for a next token). Thus, the output of the generative AI foundation model 610 is effectively fed back to its input via feedback path 613.

The exemplary generative AI foundation model 610 described herein may be a generative AI type of model with Open Pre-trained Transformer (OPT) architecture. Reference to OPT architecture indicates that the architecture is based on a decoder-only transformer stack. The data from the variety of sources may include data obtained from various infrastructure vendors (original equipment manufacturers (OEMs) of wireless network infrastructure). The data from the variety of sources may include data obtained from a quantity of geographical regions. The data from the variety of sources may include data obtained from a quantity markets. The data from the variety of sources may include data obtained from a variety of radio models corresponding to those mentioned in technical standards documents, such as but not limited to the technical standards documents related to 3GPP 5G NR wireless protocols. Digital twins (or simulators) for or corresponding to each of these entities may also be employed to obtain data. Of course, the variety of sources are not limited to these examples, and it is within the scope of the disclosure to obtain the data from the variety of sources from other/additional sources.

As used herein, the terms fine-tuned and pretrained (as well as their forms, e.g., fine-tune, fine-tuning and pretrain, pretraining) may be associated. The act of fine-tuning may involve taking a small amount of new data and in combination with the pretrained model, train a small embedding or fingerprint with the new data in combination with the pretrained model.

The term “UE capability” as used herein may be a reference to any capability advertised by the UE via an RRC Capability Update message. UE capabilities may include, but are not limited to, band combinations supported, new MIMO configurations (e.g., 6RX), Supplementary UL (SUL) capabilities, etc.

As described above, the 3GPP 5G NR Technical Specifications require a UE to support up to 16 HARQ processes per cell and 16 cells via carrier aggregation. In practice, the number of HARQ processes to expect and the memory required per process varies based on, for example, any one or more of the BLER Target specified in an Outer Loop parameter of a given network entity (e.g., of a given gNB), UE-network entity grant history and HARQ history, traffic for the UE at the network entity, load on the network entity (from the UE and all other UEs being served by the network entity), and network entity implementation.

As explained above, there are several classifications (e.g., categories, levels, designations, types) of memories (e.g., memory buffers) associated with downlink (DL) data reception. A first classification of buffer memory may be referred to as HARQ buffer memory. A second classification of buffer memory may be referred to as logical channel buffer memory (where data may be temporarily stored while it awaits out-of-order data, such that all data may be delivered to higher layers in-order).

According to some aspects of the disclosure, a generative AI foundation model (sometimes referred to as a foundation LLM herein) (such as the generative AI foundation model 610 as shown and described in connection with FIG. 6) may be deployed on the UE side. Many parameters that determine the efficacy of a UE-network entity Link Adaptation (and by extension the QoS experienced over a given link) in NR are not directly observed by the UE. For example, network entity scheduler parameters, load on the network entity, a presence of and a content of the Outer Loop parameter, a value of the Proportionally Fair parameter utilized by the network entity, a presence and quantity (e.g., amount) of traffic handled by the network entity, the class(es) of traffic handled by the network entity, etc. may not be directly observed by the UE.

The generative AI foundation model 610 may be pretrained on a large amount of data that may be obtained at least in part, from simulations and commercial trials. The generative AI foundation model may learn various distributions among and/or patterns and relationships between the large amount of data which is available at the UE side. In some examples, the generative AI foundation model may learn various distributions among and/or patterns and relationships between the data that may not be directly observed by the UE, such as, but not limited to the just-mentioned network entity scheduler parameters, load on the network entity, a presence of and a content of the Outer Loop parameter, a value of the Proportionally Fair parameter utilized by the network entity, a presence and amount of traffic handled by the network entity, the class(es) of traffic handled by the network entity, etc. After pretraining, the generative AI foundation model may be used by the UE across a wide variety of contexts (e.g., a wide variety of scenarios). The generative AI foundation model 610 may be used, for example, to optimize allocations of HARQ buffer memory and/or logical channel buffer memory.

The generative AI foundation model 610 may be used to predict downlink transmissions of specific Logical Channels (LCs) over a future context of N slots (where N is a positive non-zero integer). In anticipation of future downlink transmission(s), the UE may reserve buffer memory for each specific logical channel and overall memory for all logical channels. By using the predictions, the UE may not need to reserve enough memory to (blindly) account for the worst-case scenario associated with a use of all logical channels in the context of the N slots, but instead may only need to reserve enough memory to handle the predicted number of logical channels in the context of the N slots. This allocation may need to be resized based on changes in the conditions at either end. Although exemplified in terms of reserving buffer memory for downlink, there is an equivalent buffer memory for uplink. For the sake of brevity, the descriptions herein will not be repeated for the equivalent buffer memory for the uplink; however, it will be understood that the scope of the disclosure is intended to cover examples and aspects related to downlink and their equivalents in uplink.

Additionally, the generative AI foundation model 610 may be leveraged to predict overall downlink data rates for each logical channel and overall downlink activity, then the UE can anticipate the overall buffer memory required and configure a potentially more realistic value of memory as opposed to configuring a worst case amount of memory (as may be configured at the UE by a network entity).

The (implicit) statistics derived from the generative AI foundation model 610 or outputs obtained from the sampling 612 or task specific head 614 circuits/functions, may be used as input to a dynamic memory management controller 616. Based on these statistics or outputs, the dynamic memory management controller 616 may flexibly adapt the amount of HARQ buffer memory and/or logical channel buffer memory to allocate in one or more memories 618. The flexibly adapted buffer memory allocations may be based on many parameters that the UE cannot directly observe but are implicitly modeled in the generative AI foundation model 610. Utilization of the dynamic memory management controller 616 in conjunction with the output of the generative AI foundation model 610, output of the sampling 612 circuit/function, and/or output of the task specific head 614 may improve (e.g., enhance) the performance/utilization of the one or more memories.

According to some aspects, the generative AI foundation model system 600 may be configured to at least one of: reserve a first amount of one or more memories to use with a HARQ process identified by the HARQ process identifier based on at least one of: the predicted downlink grant arrival time, the predicted burst duration, or the predicted burst arrival time, reserve a second amount of the one or more memories to use with a logical channel identified by a logical channel identifier based on at least one of: the predicted downlink grant arrival time, the predicted burst duration, or the predicted burst arrival time, and the predicted block error rate, or release a third amount of the one or more memories from a previous reservation.

In some examples, the generative AI foundation model system 600 may be further configured to predict a downlink transmission in each of one or more logical channels, each identified with a logical channel identifier, within a future context of N slots, where N is a non-zero positive whole number. Still further, the generative AI foundation model system 600 may be further configured to determine reservation for a specific amount of a memory for each of the one or more logical channels and an overall amount of the memory for all of the one or more the logical channels. Furthermore, the generative AI foundation model system 600 may be further configured to predict a downlink data rate of each of the one or more logical channels, and reserve an amount of a memory for all of the one or more logical channels based at least in part on the predicted downlink data rate, block error rate, burst arrival rate, etc. of the each of the one or more logical channels.

As known to persons having ordinary skill in the art, there may be differences between the memory reserved for HARQ processes and the memory reserved for logical channels. One difference between the memories is that logical channel buffer memory is expected to be assembled/available in-order to the upper layer. HARQ buffer memory, and specifically HARQ log-likelihood ratio (LLR) memory, may be present at only layer 2 (L2) and may not have the same in-order assembly/availability constraint as logical channel buffer memory. It is noted that HARQ buffer memory may be used for several purposes-besides state maintenance—for various subtasks involved in PDSCH grant decoding, etc. Accordingly, HARQ buffer memory is very costly, and its allocation impacts not only HARQ processes, but other aspects related to PDSCH decoding as well.

In addition to the constraint of the in-order assembly/availability of logical channel buffer memory, the value of block error rate plays a part in determining how much memory to reserve for logical channel buffer memory. For example, having a higher block error rate involves maintaining more state and this causes fluctuations in both usage of memory and latency of parsing data stored in the memory. For example, in association with a higher block error rate, a UE may need to maintain older packets in memory longer to satisfy the in-order delivery requirement. Consequently, as new packets arrive, the UE may still be waiting for older packets in the memory to be delivered successfully. Thus, the generative AI foundation model that may accurately/realistically predict the block error rate should positively impact memory usage reservation in the logical channel buffer memory pool.

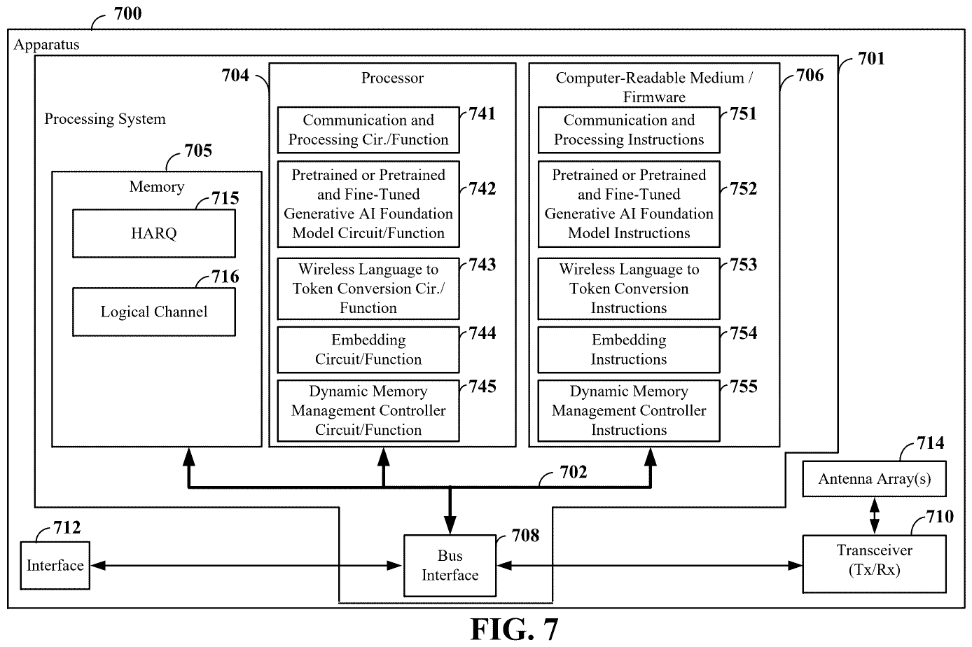

FIG. 7 is a block diagram illustrating an example of a hardware implementation of an apparatus 700 (e.g., a UE, a wireless communication device, a scheduled entity, a server), employing one or more processing systems (generally represented by processing system 701) according to some aspects of the disclosure. The apparatus 700 may be similar to, for example, any of the scheduled entities 106 as shown and described in connection with FIG. 1, any of the UEs 222, 224, 230, 232, 234, 236, 238, 240, 242 as shown and described in connection with FIG. 2, the server 244 as shown and described in connection with FIG. 2, the UEs as shown and described in FIG. 4, and/or the generative AI foundation model system 600 as shown and described in connection with FIG. 6. According to some aspects of the disclosure the apparatus may be a user equipment, a server in real-time communication with the user equipment, or distributed between the user equipment and the server.

In accordance with various aspects of the disclosure, an element, any portion of an element, or any combination of elements may be implemented with a processing system 701 that includes one or more processors, generally represented by processor 704, and one or more memories, generally represented by the memory 705, and additionally or alternatively one or more computer-readable media, generally represented by the computer-readable medium 706. Examples of processor 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 700 may be configured to perform any one or more of the functions described herein. That is the one or more processors (generally represented by processor 704), as utilized in the apparatus 700, may be configured to, individually or collectively, based at least in part on information stored in the one or more memories (generally represented by the memory 705 and additionally or alternatively generally represented by the computer-readable medium 706), implement (e.g., perform) any one or more of the methods or processes described and illustrated, for example, in connection with FIGS. 1, 2, and/or 6.

In this example, the processing system 701 may be implemented with a bus architecture, represented generally by the bus 702. The 702 bus may include any number of interconnecting buses and bridges depending on the specific application of the processing system 701 and the overall design constraints. The bus 702 communicatively couples together various circuits, including one or more processors (generally represented by the processor 704), one or more memories (generally represented by the memory 705), and one or more computer-readable media (generally represented by the computer-readable medium 706). The bus 702 may also link various other circuits such as power supply circuits 760, timing sources, peripherals, voltage regulators, and power management circuits, which are well known to persons having ordinary skill in the art and, therefore, will not be described any further.

A bus interface 708 provides an interface between the bus 702 and a transceiver 710 and associated hardware such as the antenna(s)/antenna array(s) 714. The transceiver 710 may be, for example, a wireless transceiver. The transceiver 710 may be operational with multiple RATs (e.g., LTE, 5G NR, IEEE 802.11 (WiFi®), etc.). The transceiver 710 may provide respective means for communicating with various other apparatus, UEs, network entities, base stations, and core networks over a transmission medium (e.g., air interface). The transceiver 710 may be coupled to one or more respective antenna(s)/antenna array(s) 714. The bus interface 708 may provide an interface between the bus 702 and a user interface 712 (e.g., keypad, display, touch screen, speaker, microphone, control features, vibration circuit/device, etc.). Of course, such a user interface 712 is optional and may be omitted in some examples. In a case where the apparatus 700 is included in a server, the transceiver 710 and antenna array(s) 714 may be located remotely from the server and may be configured as a transceiver and antenna array(s) of a network entity.

The one or more processors, represented individually and collectively by processor 704, may be responsible for managing the bus 702 and general processing, including the execution of software stored on the one or more memories (represented individually and collectively by a memory 705) and/or on the one or more computer-readable media (represented individually and collectively by a computer-readable medium 706). Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the memory 705 and/or the computer-readable medium 706. The software, when executed by the one or more processors (generally represented by processor 704), causes the processing system 701 to perform the various processes and functions described herein for any particular apparatus.

The computer-readable medium 706 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, any computer readable memory device, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 701, external to the processing system 701, or distributed across multiple entities, including the processing system 701. The computer-readable medium 706 may be embodied in a computer program product or article of manufacture. For example, a computer program product or article of manufacture may include a computer-readable medium in packaging materials. In some examples, the computer-readable medium 706 may be part of the memory 705.

Persons having ordinary skill in the art will recognize how best to implement the described functionality presented throughout this disclosure depending on the particular application and the overall design constraints imposed on the overall system. The computer-readable medium 706 and/or the memory 705 may also be used for storing data that is manipulated by the processor 704 when executing software.

In some aspects of the disclosure, the one or more processors (generally represented by processor 704) may include a communication and processing circuit/function 741 configured for various functions, including, for example, communicating with a network entity (e.g., a base station, a gNB, a scheduling entity), a core network, and/or a server. In some examples, the communication and processing circuit/function 741 may include one or more hardware components that provide the physical structure that performs processes related to wireless communication (e.g., signal reception and/or signal transmission) and signal processing (e.g., processing a received signal and/or processing a signal for transmission). The communication and processing circuit/function 741 may further be configured to execute communication and processing instructions 751 (e.g., software) stored, for example, on the computer-readable medium 706 to implement one or more functions described herein.

In some aspects of the disclosure, the processor 704 may include (or be configured as, at least in part) a pretrained or pretrained and fine-tuned generative AI foundation model circuit/function (referred to herein as the generative AI foundation model circuit/function 742) configured for various functions, including, for example, operating as a pretrained or pretrained and fine-tuned generative AI foundation model, using at least a language that models a wireless protocol. According to some aspects, the wireless protocol may be a 3rd Generation Partnership Project (3GPP) 5G New Radio (NR) wireless protocol. The generative AI foundation model circuit/function 742 may be further configured to capture patterns and relationships between embeddings, expressed implicitly in statistics, (obtained by use of the embedding circuit/function 744) using the generative AI foundation model, and outputting a sequence of predicted tokens based on the (captured) patterns and relationships between the embeddings, the sequence of predicted tokens including at least one of: a predicted downlink grant arrival time, a predicted burst duration, a predicted burst arrival time, or a predicted block error rate. According to some aspects, the generative AI foundation model circuit/function 742 may be further configured to provide the predicted downlink grant arrival time, the predicted burst duration, the predicted burst arrival time, or the predicted block error rate on a token-by-token basis or on a slot-by-slot basis. According to some aspects, the processor 704 may be configured to operate the generative artificial intelligence (AI) foundation model using autoregressive prediction.

According to some aspects, the generative AI foundation model circuit/function 742 may further be configured to predict a downlink transmission in each of one or more logical channels, each identified with a logical channel identifier, within a future context of N slots, where N is a non-zero positive whole number. The generative AI foundation model circuit/function 742 may still further be configured to reserve a specific amount of a memory for each of the one or more logical channels and an overall amount of the memory for all of the one or more the logical channels. In this aspect, a gain may not come from saving on how many logical channels to maintain in the memory (as in the case of HARQ); memory should be maintained for all logical channels. Instead, a gain associated with use of the generative AI foundation model circuit/function 742 may be realized in terms of, for example, how much memory to maintain, which may be dictated by the BLER, and on how long to maintain the data in the memory, which may depend, for example, on retransmission duration, which is a network entity side implementation parameter (which a UE may never directly observe). The generative AI foundation model circuit/function 742 may still further be configured to predict a downlink data rate of each of the one or more logical channels, and reserve an amount of a memory for all of the one or more logical channels based at least in part on the predicted downlink data rate of the each of the one or more logical channels.

The generative AI foundation model circuit/function 742 may further be configured to execute generative AI foundation model instructions 752 (e.g., software) stored, for example, on the computer-readable medium 706 or elsewhere as firmware to implement one or more functions described herein.

In some aspects of the disclosure, the processor 704 may include (or be configured as, at least in part) a wireless language to token conversion circuit/function 743, configured for various functions, including, for example, receiving wireless language according to the wireless protocol and converting the wireless language to tokens. The wireless language to token conversion circuit/function 743 may further be configured to execute wireless language to token conversion instructions 753 (e.g., software) stored, for example, on the computer-readable medium 706 or elsewhere as firmware to implement one or more functions described herein.

In some aspects of the disclosure, the processor 704 may include (or be configured as, at least in part) an embedding circuit/function 744, configured for various functions, including, for example, mapping each of the tokens to the (pretrained or pretrained and fine-tuned) generative AI foundation model circuit/function as embeddings. The embedding circuit/function 744 may further be configured to execute embedding instructions 754 (e.g., software) stored, for example, on the computer-readable medium 706 or elsewhere as firmware to implement one or more functions described herein.

In some aspects of the disclosure, the processor 704 may include (or be configured as, at least in part) a dynamic memory management controller circuit/function 745, configured for various functions, including, for example, performing dynamic memory management control of the one or more memories (represented by memory 705), where, the processor 704 may be configured to capture patterns and relationships between the embeddings, expressed implicitly in statistics, using the generative AI foundation model circuit/function 742, and apply the statistics, an output of the generative AI foundation model circuit/function 742, or both to dynamic memory management control, where the dynamic memory management control adapts an amount of hybrid automatic repeat request (HARQ) buffer memory and/or logical channel buffer memory to allocate or release in the one or more memories.

According to some aspects, the statistics, the output of the generative AI foundation model, or both are representative of at least one of a predicted grant parameter or a predicted grant decode result. In some examples, the predicted grant parameter, may include at least one of: modulation and coding scheme, rank, transport block size, HARQ process identifier, and the predicted grant decode result, may include at least a HARQ acknowledgement/negative acknowledgement (ACK/NAK). According to some aspects, the one or more processors may be further configured to derive a predicted block error rate (BLER) and a predicted burst duration from one or both of the at least one of: the predicted grant parameter or the predicted grant decode result.

According to other aspects, the dynamic memory management controller circuit/function 745 may reserve a first amount of memory for a HARQ process identified by a HARQ process identifier based on at least one of: the predicted downlink grant arrival time, the predicted burst duration, or the predicted burst arrival time, obtained by the generative AI foundation model circuit/function 742, or reserve a second amount of memory for a logical channel identified by a logical channel identifier based on: at least one of: the predicted downlink grant arrival time, the predicted burst duration, or the predicted burst arrival time, and the predicted block error rate, also obtained by the generative AI foundation model circuit/function 742. Both the first amount of memory and the second amount of memory are flexible quantities of memory. According to the flexible memory scheme described herein, the first amount of memory may be stored in a HARQ memory/HARQ buffer memory 715 location in the memory 705. Also, according to the flexible memory scheme described herein, the second amount of memory may be stored in a logical channel memory/logical channel buffer memory 716 location in the memory 705. The sizes of the HARQ memory/HARQ buffer memory 715 and the logical channel memory/logical channel buffer memory 716 are independent and may vary depending, for example, on the predictions of a downlink grant arrival time, a predicted burst duration, a predicted burst arrival time, a predicted block error rate, or any combination thereof.

The dynamic memory management controller circuit/function 745 may further be configured to execute dynamic memory management controller instructions 755 (e.g., software) stored, for example, on the computer-readable medium 706 or elsewhere as firmware to implement one or more functions described herein.

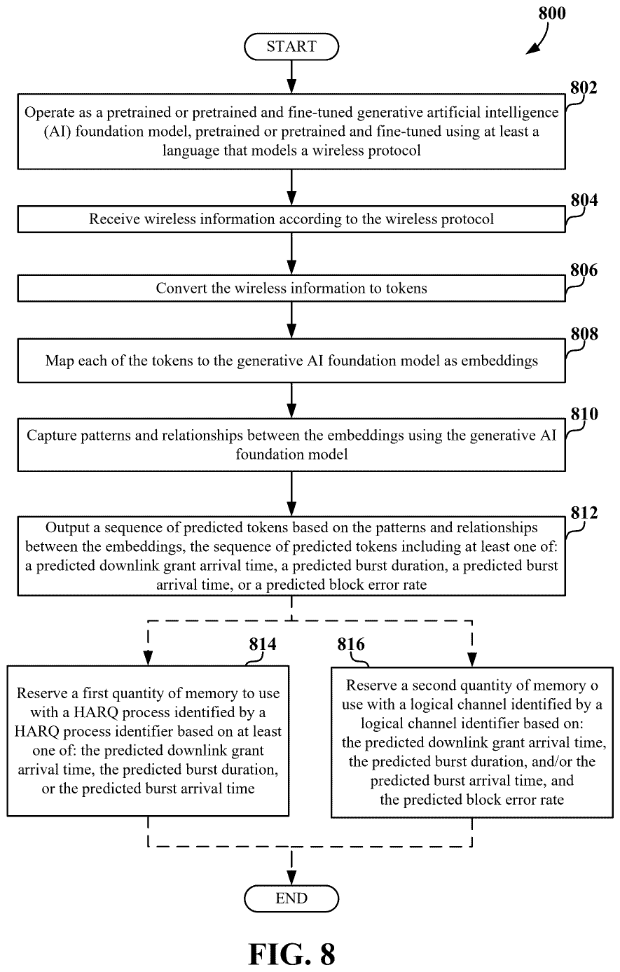

FIG. 8 is a flow chart illustrating an example process 800 (e.g., a method) of flexible memory management at an apparatus (e.g., a UE, a scheduled entity, a sidelink UE, a server) in accordance with some aspects of the disclosure. In some examples, the apparatus may be a user equipment, a server in real-time communication with the user equipment, or distributed between the user equipment and the server. As described below, some or all illustrated features may be omitted in a particular implementation within the scope of the present disclosure, and some illustrated features may not be required for implementation of all embodiments. In some examples, the process 800 may be carried out by the apparatus 700, as shown and described in connection with FIG. 7. The apparatus 700 (FIG. 7) may be similar to, for example, any of the scheduled entities, servers, pretrained or pretrained and fine-tuned generative AI foundation model systems of FIGS. 1, 2, 6, and/or 7. In some examples, the process 800 may be carried out by any suitable apparatus or means for carrying out the functions or algorithm described below.

At block 802, the apparatus may operate as a pretrained or pretrained and fine-tuned generative artificial intelligence (AI) foundation model, pretrained or pretrained and fine-tuned using at least a wireless language that models a wireless protocol. For example, the generative AI foundation model circuit/function 742 as shown and described in connection with FIG. 7, may provide a means for operating as a generative artificial intelligence (AI) foundation model that was pretrained using at least a language that models a wireless protocol. According to some aspects, the wireless protocol may be a 3rd Generation Partnership Project (3GPP) 5G New Radio (NR) wireless protocol. According to some aspects, the generative artificial intelligence (AI) foundation model may operate using a method that includes autoregressive prediction.

At block 804, the apparatus may receive wireless language according to the wireless protocol. For example, the wireless language to token conversion circuit/function 743, the interface 712, and/or the transceiver 710 in cooperation with the antenna array(s) 714 as shown and described in connection with FIG. 7, may provide a means for receiving wireless language according to the wireless protocol.

At block 806, the apparatus may convert the wireless language to tokens. For example, the wireless language to token conversion circuit/function 743, as shown and described in connection with FIG. 7, may provide a means for converting the wireless language to tokens.

At block 808, the apparatus may map each of the tokens to the generative AI foundation model as embeddings. For example, the embedding circuit/function 744, as shown and described in connection with FIG. 7, may provide a means for mapping each of the tokens to the generative AI foundation model as embeddings.

At block 810, the apparatus may capture patterns and relationships between the embeddings, expressed implicitly in statistics, using the generative AI foundation model. For example, the generative AI foundation model circuit/function 742 as shown and described in connection with FIG. 7, may provide a means for capturing patterns and relationships between the embeddings, expressed implicitly in statistics, using the generative AI foundation model.

At block 812, the apparatus may output a sequence of predicted tokens based on the patterns and relationships between the embeddings, the sequence of predicted tokens including at least one of: a predicted downlink grant arrival time, a predicted burst duration, a predicted burst arrival time, or a predicted block error rate. For example, the generative AI foundation model circuit/function 742, as shown and described in connection with FIG. 7, may provide a means for outputting a sequence of predicted tokens based on the patterns and relationships between the embeddings, the sequence of predicted tokens including at least one of: a predicted downlink grant arrival time, a predicted burst duration, a predicted burst arrival time, or a predicted block error rate.

Thereafter, the process 800 may end. However, prior to ending, further alternative options may be carried out by the apparatus.

For example, according to some aspects, at block 814, the apparatus may optionally reserve a first amount of memory to use with a HARQ process identified by a HARQ process identifier based on at least one of: the predicted downlink grant arrival time, the predicted burst duration, or the predicted burst arrival time. For example, the communication and processing circuit/function 741, as shown and described in connection with FIG. 7, may provide a means for reserving a first amount of memory to use with a HARQ process identified by a HARQ process identifier based on at least one of: the predicted downlink grant arrival time, the predicted burst duration, or the predicted burst arrival time.

For example, according to some aspects, at block 816, the apparatus may optionally reserve a second amount of memory to use with a logical channel identified by a logical channel identifier based on: the predicted downlink grant arrival time, the predicted burst duration, and/or the predicted burst arrival time, and the predicted block error rate. For example, the communication and processing circuit/function 741, as shown and described in connection with FIG. 7, may provide a means for reserving a second amount of memory to use with a logical channel identified by a logical channel identifier based on: the predicted downlink grant arrival time, the predicted burst duration, and/or the predicted burst arrival time, and the predicted block error rate.

According to some examples (not shown) of the process 800, the apparatus may provide the predicted downlink grant arrival time, the predicted burst duration, the predicted burst arrival time, or the predicted block error rate on a token-by-token basis or on a slot-by-slot basis. According to some examples (not shown) of the process 800, the apparatus may also predict a downlink transmission in each of one or more logical channels, each identified with a logical channel identifier, within a future context of N slots, where N is a non-zero positive whole number. The apparatus may still further reserve a specific amount of a memory for each of the one or more logical channels and an overall amount of the memory for all of the one or more the logical channels. The apparatus may still further predict a downlink data rate of each of the one or more logical channels and reserve an amount of a memory for all of the one or more logical channels based at least in part on the predicted downlink data rate of the each of the one or more logical channels.

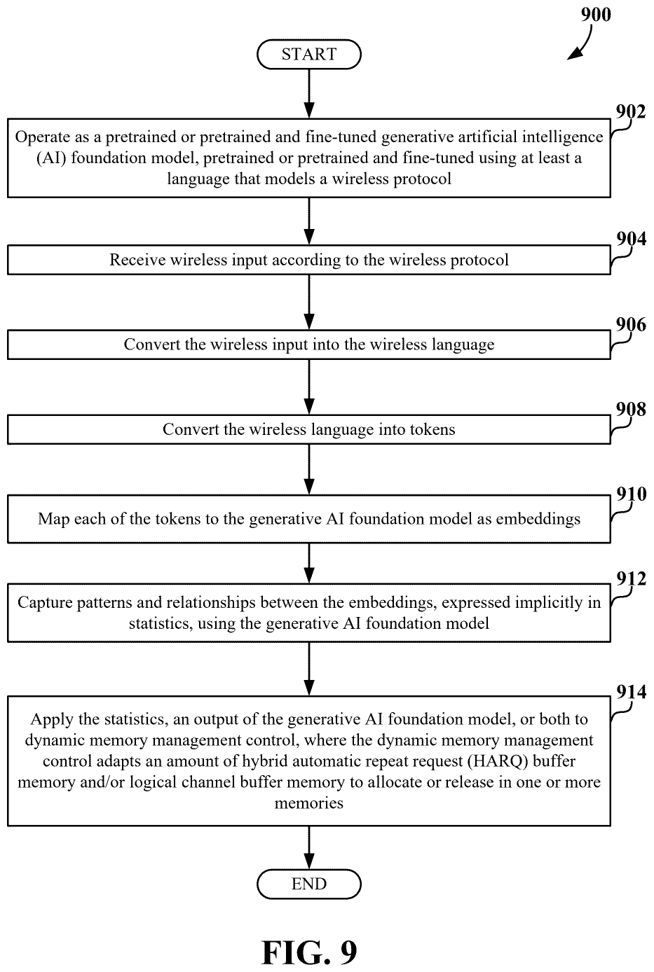

FIG. 9 is a flow chart illustrating an example process 900 (e.g., a method) of flexible memory management at an apparatus (e.g., a UE, a scheduled entity, a sidelink UE, a server) in accordance with some aspects of the disclosure. In some examples, the apparatus may be a user equipment, a server in real-time communication with the user equipment, or distributed between the user equipment and the server. As described below, some or all illustrated features may be omitted in a particular implementation within the scope of the present disclosure, and some illustrated features may not be required for implementation of all embodiments. In some examples, the process 900 may be carried out by the apparatus 700, as shown and described in connection with FIG. 7. The apparatus 700 (FIG. 7) may be similar to, for example, any of the scheduled entities, servers, or generative AI foundation model systems of FIGS. 1, 2, 6, and/or 7. In some examples, the process 900 may be carried out by any suitable apparatus or means for carrying out the functions or algorithm described below.

At block 902, the apparatus may operate one of a pretrained or a pretrained and fine-tuned generative artificial intelligence (AI) foundation model (herein referred to as the generative AI foundation model), which was pretrained or pretrained and fine-tuned using at least a language that models a wireless protocol. For example, the generative AI foundation model circuit/function 742, as shown and described in connection with FIG. 7, may provide a means for operating as one of a pretrained or pretrained and fine-tuned) generative AI foundation model, which was pretrained or pretrained and fine-tuned using at least a wireless language that models a wireless protocol. According to some aspects, the wireless language may represent one or more wireless protocols, such as, by way of example and not limitation, any standardized wireless protocol such as any wireless protocol standardized currently or in the future by the Third Generation Partnership Project (3GPP) (e.g., 3GPP 5G NR wireless protocol or a forthcoming 6G wireless protocol) or the Institute of Electrical and Electronics Engineers (IEEE). According to some aspects, the generative AI foundation model may operate using a method that includes autoregressive prediction.

At block 904, the apparatus may receive wireless input according to the wireless protocol. For example, the wireless language to token conversion circuit/function 743, the interface 712, and/or the transceiver 710 in cooperation with the antenna array(s) 714 as shown and described in connection with FIG. 7, may provide a means for receiving wireless input according to the wireless protocol. According to some aspects, the wireless input may include at least one of: wireless signals, configurations, settings, values, and/or fields represented by the wireless signals, configurations, and/or the settings, associated conditions at either the apparatus or a network entity, or user intent.

At block 906, the apparatus may convert the wireless input into the wireless language. For example, at least one aspect of the wireless language to token conversion circuit/function 743, as shown and described in connection with FIG. 7, may provide a means for converting the wireless input into the wireless language. The at least one aspect of the wireless language to token conversion circuit/function 743 may be the wireless language conversion 604 aspect as shown and described in connection with FIG. 6.

At block 908, the apparatus may convert the wireless language into tokens. For example, at least one aspect of the wireless language to token conversion circuit/function 743, as shown and described in connection with FIG. 7, may provide a means for converting the wireless language into tokens. The at least one aspect of the wireless language to token conversion circuit/function 743 may be the tokenization 606 aspect as shown and described in connection with FIG. 6.

At block 910, the apparatus may map each of the tokens to the generative AI foundation model as embeddings. For example, the embedding circuit/function 744, as shown and described in connection with FIG. 7, may provide a means for mapping each of the tokens to the generative AI foundation model as embeddings.

At block 912, the apparatus may capture patterns and relationships between the embeddings, expressed implicitly in statistics, using the generative AI foundation model. For example, the pretrained or pretrained and fine-tuned generative AI foundation model circuit/function 742, as shown and described in connection with FIG. 7, may provide a means for capturing patterns and relationships between the embeddings, expressed implicitly in statistics, using the generative AI foundation model.

At block 914, the apparatus may apply the statistics, an output of the generative AI foundation model, or both to dynamic memory management control, where the dynamic memory management control adapts an amount of hybrid automatic repeat request (HARQ) buffer memory and/or logical channel buffer memory to allocate or release in one or more memories. For example, the generative AI foundation model circuit/function 742, as shown and described in connection with FIG. 7, may provide a means for applying the statistics, an output of the generative AI foundation model, or both to dynamic memory management control, where the dynamic memory management control adapts an amount of hybrid automatic repeat request (HARQ) buffer memory and/or logical channel buffer memory to allocate or release in one or more memories. According to some aspects, the statistics, the output of the generative AI foundation model, or both may be representative of at least one of predicted grant parameter or a predicted grant decode result. In some examples, the predicted grant parameter may include at least one of: modulation and coding scheme, rank, transport block size, or HARQ process identifier, and the predicted grant decode result may include at least a HARQ acknowledgement/negative acknowledgement (ACK/NAK). In some examples, the generative AI foundation model may be further configured to derive a predicted block error rate (BLER) and a predicted burst duration from one or both of the at least one of: the predicted grant parameter or the predicted grant decode result. For example, the communication and processing circuit/function 741, as shown and described in connection with FIG. 7, may provide a means for deriving a predicted block error rate (BLER) and a predicted burst duration from one or both of the at least one of: the predicted grant parameter or the predicted grant decode result.

Thereafter, the process 900 may end.

According to some aspects, the generative AI foundation model may be configured to output a sequence of predicted tokens based on the patterns and relationships between the embeddings, the sequence of predicted tokens representing at least one of: a predicted modulation and coding scheme, a predicted rank, a predicted transport block size, a predicted HARQ process identifier, a predicted HARQ acknowledgement/negative acknowledgement (ACK/NAK), a predicted downlink grant arrival time, or a predicted burst arrival time. For example, the pretrained or pretrained and fine-tuned generative AI foundation model circuit/function 742, as shown and described in connection with FIG. 7, may provide a means for outputting a sequence of predicted tokens based on the patterns and relationships between the embeddings, the sequence of predicted tokens representing at least one of: a predicted modulation and coding scheme, a predicted rank, a predicted transport block size, a predicted HARQ process identifier, a predicted HARQ acknowledgement/negative acknowledgement (ACK/NAK), a predicted downlink grant arrival time, or a predicted burst arrival time.

According to some aspects, the generative AI foundation model may be configured to cause the dynamic memory management controller to adapt the amount of hybrid automatic repeat request (HARQ) buffer memory and/or logical channel buffer memory to allocate or to release by being further configured to at least one of: reserve a first amount of the one or more memories to use with a HARQ process identified by a HARQ process identifier based on at least one of: a predicted downlink grant arrival time, a predicted burst duration, or a predicted burst arrival time, reserve a second amount of the one or more memories to use with a logical channel identified by a logical channel identifier based on at least one of: the predicted downlink grant arrival time, the predicted burst duration, or the predicted burst arrival time, and a predicted block error rate, or release a third amount of the one or more memories from a previous reservation. For example, the dynamic memory management controller circuit/function 745, as shown and described in connection with FIG. 7, may provide a means for causing the dynamic memory management controller to adapt the amount of hybrid automatic repeat request (HARQ) buffer memory and/or logical channel buffer memory to allocate or to release. For example, the dynamic memory management controller circuit/function 745, as shown and described in connection with FIG. 7, may provide a means for reserving a first amount of the one or more memories to use with a HARQ process identified by a HARQ process identifier based on at least one of: a predicted downlink grant arrival time, a predicted burst duration, or a predicted burst arrival time. For example, the dynamic memory management controller circuit/function 745, as shown and described in connection with FIG. 7, may provide a means for reserving a second amount of the one or more memories to use with a logical channel identified by a logical channel identifier based on at least one of: the predicted downlink grant arrival time, the predicted burst duration, or the predicted burst arrival time, and a predicted block error rate. For example, the dynamic memory management controller circuit/function 745, as shown and described in connection with FIG. 7, may provide a means for releasing a third amount of the one or more memories from a previous reservation.

According to some aspects, the generative AI foundation model may be configured to provide at least one of: a predicted downlink grant arrival time, a predicted burst duration, a predicted burst arrival time, or a predicted block error rate on a token-by-token basis or on a slot-by-slot basis over a predetermined number of next slots or seconds. For example, the pre-trained or pretrained and fine-tuned generative AI foundation model circuit/function 742, as shown and described in connection with FIG. 7, may provide a means for providing at least one of: a predicted downlink grant arrival time, a predicted burst duration, a predicted burst arrival time, or a predicted block error rate on a token-by-token basis or on a slot-by-slot basis over a predetermined number of next slots or seconds.

Of course, in the above examples, the circuitry included in the one or more processors 704 of FIG. 7 are merely provided as examples. Other means for carrying out the described processes or functions may be included within various aspects of the present disclosure, including but not limited to the instructions stored in the one or more memories 705 and/or one or more computer-readable medium 706 of FIG. 7, or any other suitable apparatus or means described in any one of the FIGS. 1, 2, 4, 6, and/or 7 utilizing, for example, the processes and/or algorithms described herein in relation to FIGS. 6, 8, and/or 9.

The following provides an overview of aspects of the present disclosure:

Aspect 1: An apparatus, comprising: one or more memories; and one or more processors coupled to the one or more memories, the one or more processors being configured to, individually or collectively, based at least in part on information stored in the one or more memories: operate one of a pretrained or a pretrained and fine-tuned generative artificial intelligence (AI) foundation model (the generative AI foundation model), pretrained or pretrained and fine-tuned using at least a wireless language that models a wireless protocol, receive a wireless input according to the wireless protocol, convert the wireless input into the wireless language, convert the wireless language into tokens, map each of the tokens to the generative AI foundation model as embeddings, capture patterns and relationships between the embeddings, expressed implicitly in statistics, using the generative AI foundation model, and apply the statistics, an output of the generative AI foundation model, or both to a dynamic memory management controller, where the dynamic memory management controller adapts an amount of hybrid automatic repeat request (HARQ) buffer memory and/or logical channel buffer memory to allocate or release in the one or more memories.

Aspect 2: The apparatus of aspect 1, where the one or more processors are further configured to operate the generative AI foundation model using autoregressive prediction.

Aspect 3: The apparatus of aspect 1 or aspect 2, where the statistics, the output of [0166] the generative AI foundation model, or both are representative of at least one of a predicted grant parameter or a predicted grant decode result.

Aspect 4: The apparatus of any one of aspects 1 through 3, where: the predicted grant parameter comprises at least one of: modulation and coding scheme, rank, transport block size, or HARQ process identifier, and the predicted grant decode result comprises at least a HARQ acknowledgement/negative acknowledgement (ACK/NAK).

Aspect 5: The apparatus of any one of aspects 1 through 4, where the one or more processors are further configured to derive a predicted block error rate and a predicted burst duration from one or both of the at least one of: the predicted grant parameter or the predicted grant decode result.

Aspect 6: The apparatus of any one of aspects 1 through 5, where the one or more processors are further configured to output a sequence of predicted tokens based on the patterns and relationships between the embeddings, the sequence of predicted tokens representing at least one of: a predicted modulation and coding scheme, a predicted rank, a predicted transport block size, a predicted HARQ process identifier, a predicted HARQ acknowledgement/negative acknowledgement (ACK/NAK), a predicted downlink grant arrival time, or a predicted burst arrival time.

Aspect 7: The apparatus of any one of aspects 1 through 6, where the wireless input comprises at least one of: wireless signals, configurations, settings, values, and/or fields represented by the wireless signals, configurations, and/or the settings, associated conditions at either the apparatus or a network entity, or user intent.

Aspect 8: The apparatus of any one of aspects 1 through 7, where the one or more processors are further configured to cause the dynamic memory management controller to adapt the amount of hybrid automatic repeat request (HARQ) buffer memory and/or logical channel buffer memory to allocate or to release by being further configured to at least one of: reserve a first amount of the one or more memories to use with a HARQ process identified by a HARQ process identifier based on at least one of: a predicted downlink grant arrival time, a predicted burst duration, or a predicted burst arrival time, reserve a second amount of the one or more memories to use with a logical channel identified by a logical channel identifier based on at least one of: the predicted downlink grant arrival time, the predicted burst duration, or the predicted burst arrival time, and a predicted block error rate, or release a third amount of the one or more memories from a previous reservation.

Aspect 9: The apparatus of any one of aspects 1 through 8, where the one or more processors are further configured to provide at least one of: a predicted downlink grant arrival time, a predicted burst duration, a predicted burst arrival time, or a predicted block error rate on a token-by-token basis or on a slot-by-slot basis over a predetermined number of next slots or seconds.

Aspect 10: The apparatus of any one of aspects 1 through 9, where the apparatus is a user equipment, a server in real-time communication with the user equipment, or distributed between the user equipment and the server.

Aspect 11: An apparatus, comprising: means for operating as a pretrained or a pretrained and fine-tuned generative artificial intelligence (AI) foundation model (the generative AI foundation model), pretrained or pretrained and fine-tuned using at least a wireless language that models a wireless protocol; means for receiving a wireless input according to the wireless protocol; means for converting the wireless input into the wireless language; means for converting the wireless language to tokens; means for mapping each of the tokens to the generative AI foundation model as embeddings; means for capturing patterns and relationships between the embeddings, expressed implicitly in statistics, using the generative AI foundation model; and means for applying the statistics, an output of the generative AI foundation model, or both to a dynamic memory management controller, where the dynamic memory management controller adapts an amount of hybrid automatic repeat request (HARQ) buffer memory and/or logical channel buffer memory to allocate or release in one or more memories.

Aspect 12: The apparatus of aspect 11, where the means for operating the generative AI foundation model operate the generative AI foundation model using autoregressive prediction.

Aspect 13: The apparatus of aspect 11 or aspect 12, where the statistics, the output of the generative AI foundation model, or both are representative of at least one of a predicted grant parameter or a predicted grant decode result.

Aspect 14: The apparatus of aspect 13, where: the predicted grant parameter comprises at least one of: modulation and coding scheme, rank, transport block size, HARQ process identifier, and the predicted grant decode result comprises at least a HARQ acknowledgement/negative acknowledgement (ACK/NAK).

Aspect 15: The apparatus of any one of aspects 11 through 14, where a predicted block error rate and a predicted burst duration are derived from one or both of the at least one of: the predicted grant parameter or the predicted grant decode result.

Aspect 16: The apparatus of any one of aspects 11 through 15, further comprising: means for outputting a sequence of predicted tokens based on the patterns and relationships between the embeddings, the sequence of predicted tokens representing at least one of: a predicted modulation and coding scheme, a predicted rank, a predicted transport block size, a predicted HARQ process identifier, a predicted HARQ acknowledgement/negative acknowledgement (ACK/NAK), a predicted downlink grant arrival time, or a predicted burst arrival time.

Aspect 17: The apparatus of any one of aspects 11 through 16, where the wireless input comprises at least one of: wireless signals, configurations, settings, values, and/or fields represented by the wireless signals, configurations, and/or the settings, associated conditions at either the apparatus or a network entity, or user intent.

Aspect 18: The apparatus of any one of aspects 11 through 17, further comprising: means for causing the dynamic memory management controller to adapt the amount of hybrid automatic repeat request (HARQ) buffer memory and/or logical channel buffer memory to allocate by still further comprising at least one of: means for reserving a first amount of the one or more memories to use with a HARQ process identified by a HARQ process identifier based on at least one of: a predicted downlink grant arrival time, a predicted burst duration, or a predicted burst arrival time, means for reserving a second amount of the one or more memories to use with a logical channel identified by a logical channel identifier based on: the predicted downlink grant arrival time, the predicted burst duration, and/or the predicted burst arrival time, and a predicted block error rate, or means for releasing a third amount of the one or more memories from a previous reservation.

Aspect 19: The apparatus of any one of aspects 11 through 18, further comprising: means for providing at least one of: a predicted downlink grant arrival time, a predicted burst duration, a predicted burst arrival time, or a predicted block error rate on a token-by-token basis or on a slot-by-slot basis over a predetermined number of next slots or seconds.

Aspect 20: The apparatus of any one of aspects 11 through 14, where the apparatus is a user equipment, a server in real-time communication with the user equipment, or distributed between the user equipment and the server.

Several aspects of a wireless communication network have been presented with reference to an exemplary implementation. As those skilled in the art will readily appreciate, various aspects described throughout this disclosure may be extended to other telecommunication systems, network architectures, and communication standards.

By way of example, various aspects may be implemented within other systems defined by 3GPP, such as Long Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features, and/or functions illustrated in FIGS. 1-9 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-9 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The method claims present elements of the various steps in a sample order and are not meant to be limited to the specific order or hierarchy presented unless specifically recited therein. While some examples illustrated herein depict only time and frequency domains, additional domains, such as a spatial domain, are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public, regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

As used herein, the term “determine” or “determining” encompasses a wide variety of actions and, therefore, “determining” can include calculating, computing, processing, deriving, investigating, looking up (such as via looking up in a table, a database, or another data structure), inferring, ascertaining, measuring, and the like. Also, “determining” can include receiving (such as receiving information), accessing (such as accessing data stored in memory), transmitting (such as transmitting information), and the like. Also, “determining” can include resolving, selecting, obtaining, choosing, establishing, and other similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Similarly, a phrase referring to A and/or B may include A only, B only, or a combination of A and B (i.e., the ‘/’ character may be used to represent the word ‘or’).

As used herein, “based on” is intended to be interpreted in the inclusive sense, unless otherwise explicitly indicated. For example, “based on” may be used interchangeably with “based at least in part on,” “associated with,” or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples can also be implemented in combination in a single implementation. Conversely, various features that are described in the context of a single implementation can also be implemented in multiple examples separately or in any suitable subcombination. As such, although features may be described above as acting in particular combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order or that all illustrated operations be performed to achieve desirable results. Further, the drawings may schematically depict one or more example processes in the form of a flowchart or flow diagram. However, other operations that are not depicted can be incorporated into the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together into a single software product or packaged into multiple software products.

What is claimed is:

1. An apparatus, comprising:
one or more memories; and
one or more processors coupled to the one or more memories, the one or more processors being configured to, individually or collectively, based at least in part on information stored in the one or more memories:
operate one of a pretrained or a pretrained and fine-tuned generative artificial intelligence (AI) foundation model (the generative AI foundation model), pretrained or pretrained and fine-tuned using at least a wireless language that models a wireless protocol,
receive a wireless input according to the wireless protocol,
convert the wireless input into the wireless language,
convert the wireless language into tokens,
map each of the tokens to the generative AI foundation model as embeddings,
capture patterns and relationships between the embeddings, expressed implicitly in statistics, using the generative AI foundation model, and
apply the statistics, an output of the generative AI foundation model, or both to a dynamic memory management controller,
wherein the dynamic memory management controller adapts an amount of hybrid automatic repeat request (HARQ) buffer memory and/or logical channel buffer memory to allocate or release in the one or more memories.

2. The apparatus of claim 1, wherein the one or more processors are further configured to operate the generative AI foundation model using autoregressive prediction.

3. The apparatus of claim 1, wherein the statistics, the output of the generative AI foundation model, or both are representative of at least one of a predicted grant parameter or a predicted grant decode result.

4. The apparatus of claim 3, wherein:
the predicted grant parameter comprises at least one of: modulation and coding scheme, rank, transport block size, or HARQ process identifier, and
the predicted grant decode result comprises at least a HARQ acknowledgement/negative acknowledgement (ACK/NAK).

5. The apparatus of claim 3, wherein the one or more processors are further configured to derive a predicted block error rate and a predicted burst duration from one or both of the at least one of: the predicted grant parameter or the predicted grant decode result.

6. The apparatus of claim 1, wherein the one or more processors are further configured to output a sequence of predicted tokens based on the patterns and relationships between the embeddings, the sequence of predicted tokens representing at least one of: a predicted modulation and coding scheme, a predicted rank, a predicted transport block size, a predicted HARQ process identifier, a predicted HARQ acknowledgement/negative acknowledgement (ACK/NAK), a predicted downlink grant arrival time, or a predicted burst arrival time.

7. The apparatus of claim 1, wherein the wireless input comprises at least one of: wireless signals, configurations, settings, values, and/or fields represented by the wireless signals, configurations, and/or the settings, associated conditions at either the apparatus or a network entity, or user intent.

8. The apparatus of claim 1, wherein the one or more processors are further configured to cause the dynamic memory management controller to adapt the amount of hybrid automatic repeat request (HARQ) buffer memory and/or logical channel buffer memory to allocate or to release by being further configured to at least one of:
reserve a first amount of the one or more memories to use with a HARQ process identified by a HARQ process identifier based on at least one of: a predicted downlink grant arrival time, a predicted burst duration, or a predicted burst arrival time,
reserve a second amount of the one or more memories to use with a logical channel identified by a logical channel identifier based on at least one of:
the predicted downlink grant arrival time, the predicted burst duration, or the predicted burst arrival time, and
a predicted block error rate, or
release a third amount of the one or more memories from a previous reservation.

9. The apparatus of claim 1, wherein the one or more processors are further configured to provide at least one of: a predicted downlink grant arrival time, a predicted burst duration, a predicted burst arrival time, or a predicted block error rate on a token-by-token basis or on a slot-by-slot basis over a predetermined number of next slots or seconds.

10. The apparatus of claim 1, wherein the apparatus is a user equipment, a server in real-time communication with the user equipment, or distributed between the user equipment and the server.

11. An apparatus, comprising:
means for operating as a pretrained or a pretrained and fine-tuned generative artificial intelligence (AI) foundation model (the generative AI foundation model), pretrained or pretrained and fine-tuned using at least a wireless language that models a wireless protocol;
means for receiving a wireless input according to the wireless protocol;
means for converting the wireless input into the wireless language;
means for converting the wireless language to tokens;
means for mapping each of the tokens to the generative AI foundation model as embeddings;
means for capturing patterns and relationships between the embeddings, expressed implicitly in statistics, using the generative AI foundation model; and
means for applying the statistics, an output of the generative AI foundation model, or both to a dynamic memory management controller,
wherein the dynamic memory management controller adapts an amount of hybrid automatic repeat request (HARQ) buffer memory and/or logical channel buffer memory to allocate or release in one or more memories.

12. The apparatus of claim 11, wherein the means for operating the generative AI foundation model operate the generative AI foundation model using autoregressive prediction.

13. The apparatus of claim 11, wherein the statistics, the output of the generative AI foundation model, or both are representative of at least one of a predicted grant parameter or a predicted grant decode result.

14. The apparatus of claim 13, wherein:
the predicted grant parameter comprises at least one of: modulation and coding scheme, rank, transport block size, HARQ process identifier, and
the predicted comprises at least a HARQ acknowledgement/negative acknowledgement (ACK/NAK).

15. The apparatus of claim 13, wherein a predicted block error rate and a predicted burst duration are derived from one or both of the at least one of: the predicted grant parameter or the predicted grant decode result.

16. The apparatus of claim 11, further comprising:
means for outputting a sequence of predicted tokens based on the patterns and relationships between the embeddings, the sequence of predicted tokens representing at least one of: a predicted modulation and coding scheme, a predicted rank, a predicted transport block size, a predicted HARQ process identifier, a predicted HARQ acknowledgement/negative acknowledgement (ACK/NAK), a predicted downlink grant arrival time, or a predicted burst arrival time.

17. The apparatus of claim 11, wherein the wireless input comprises at least one of: wireless signals, configurations, settings, values, and/or fields represented by the wireless signals, configurations, and/or the settings, associated conditions at either the apparatus or a network entity, or user intent.

18. The apparatus of claim 11, further comprising:
means for causing the dynamic memory management controller to adapt the amount of hybrid automatic repeat request (HARQ) buffer memory and/or logical channel buffer memory to allocate by still further comprising at least one of:
means for reserving a first amount of the one or more memories to use with a HARQ process identified by a HARQ process identifier based on at least one of: a predicted downlink grant arrival time, a predicted burst duration, or a predicted burst arrival time,
means for reserving a second amount of the one or more memories to use with a logical channel identified by a logical channel identifier based on:
the predicted downlink grant arrival time, the predicted burst duration, and/or the predicted burst arrival time, and
a predicted block error rate, or
means for releasing a third amount of the one or more memories from a previous reservation.

19. The apparatus of claim 11, further comprising:
means for providing at least one of: a predicted downlink grant arrival time, a predicted burst duration, a predicted burst arrival time, or a predicted block error rate on a token-by-token basis or on a slot-by-slot basis over a predetermined number of next slots or seconds.

20. The apparatus of claim 11, wherein the apparatus is a user equipment, a server in real-time communication with the user equipment, or distributed between the user equipment and the server.
